(19) United States
(12) Patent Application Publication
(10) Pub. No.: US 2012/0047088 A1
(43) Pub. Date: Feb. 23, 2012

(54) MODELING AND SIMULATION OF COMPLEX RELATIONSHIPS

(75) Inventor: Jerome D. JOHNSON, Waterville, MN (US)

(73) Assignee: Superior Edge, Inc., Mankato, MN (US)

(21) Appl. No.: 12/860,866

(22) Filed: Aug. 21, 2010

(51) Int. Cl. G06Q 10/00

(52) U.S. Cl. 705/348

(57) ABSTRACT

A method of modeling and simulation of complex relationships among entities is disclosed. The method can utilize a model that can graphically illustrate relationships among multiple hierarchical levels of entities, and can graphically illustrate information such as types of entities and areas operated by the entities. Further, the model can be based upon a relational database, and proposed or expected changes to the model can be simulated by changing the information in the relational database. An operation model can include a decision maker level, a business entity level, an entity owner level, and an operation level. These levels can be linked hierarchically, and family relationships can be graphically indicated based upon intestate succession priorities.

### CROSS-REFERENCE TO RELATED APPLICATIONS

None.

### FIELD OF THE INVENTION

The present subject matter relates to modeling and simulation of complex relationships among entities. More particularly, a model is provided that graphically illustrate relationships among multiple hierarchical levels of entities, and can graphically illustrate information such as types of entities and areas operated by the entities. Further, the model can be based upon a relational database, and proposed or expected changes to the model can be simulated by changing the information in the relational database.

### BACKGROUND OF THE INVENTION

In recent years, there has been an explosive proliferation of available relationship information for modeling an operation of an entity. For example, an entity such as a farm can have associated relationship information such as: decision makers (such as officers of the farm), owners of the farm, acres operated by the farm, acres operated by owners of the farm (which can include areas of other farms), crops grown on the farm, family relationships with respect to the officers of the farm and/or the owners of the farm, various direct non-family relationships, and indirect non-family relationships. The modeling can be focused on one or more key (target) entities such a key farm or a key decision maker. Proposed or expected changes to the model can be simulated by changing the information in the relational database.

Desired is a method for modeling and simulation of this vast amount of information regarding relationships.

### SUMMARY OF THE INVENTION

The teachings herein improve over conventional techniques by clearly and graphically modeling and simulating the complex relationship information of an operation of an entity.

OPERATION MODEL AND INFLUENCE MODEL In one embodiment, an operation model can graphically illustrate relationships among multiple levels of entities, and the entities can graphically illustrate information such as types of the entities and areas operated by the entities. The levels can include: decision maker, business entity, owner of the business entity, area operated by the business entity, and crop distribution of the area operated (see FIG. 1). For example, this model can include at least four levels, and a method for creating this model can comprise: generating a decision maker level including a decision maker; generating a business entity level including a business entity, wherein the business entity is linked to the decision maker; generating an entity owner level including an owner of a portion of the business entity; generating an operation level including a type of operation, wherein the type of operation is linked to the owner or linked to the business entity; generating and storing the model including the above levels; and performing at least one of the above generating steps with a computer. The order of the above steps may be varied, depending upon the focus of the modeler.

The operation level can indicate acres operated by the business entity, and an additional step can generate a crop distribution level including a crop distribution, wherein the crop distribution is linked to the type of operation. The crop distribution level can utilize a pie chart to indicate acreage allocated to each type of crop. The decision maker level can be generated before the business entity level is generated. The business entity level can be generated before the decision maker level is generated. The entity ownership level can graphically indicate a family relationship between the owner and the decision maker. The graphically indicated family relationship can be intestate succession. The decision maker can be linked to the business entity by being an officer of the business entity, or by being a member of the board of directors of the business entity. The influence relationship level can include an entity with a family relationship or a direct nonfamily relationship. The model can graphically indicate that an entity in the influence relationship level has a family relationship with the decision maker. The model can graphically indicate that an entity in the influence relationship level has a direct non-family relationship with the decision maker. The model can also include an indirect influence relationship level.

RETAIL RELATIONSHIP MODEL In a second embodiment, a retail relationship model can be generated by the following steps: generating a business entity level including a business entity; generating an influence relationship level including an influence entity, wherein the influence entity has an influence relationship with the business entity; generating a sales relationship level having a retailer, wherein the retailer is linked to the influence entity; generating a wholesaler level having a wholesaler, wherein the wholesaler is linked to the retailer; generating and storing the model including the above levels; and performing at least one of the above generating steps with a computer. See FIG. 3. The order of the steps may be varied, depending upon the focus of the modeler. For example, a business entity may be initially, selected, and the remainder of the model may be generated based upon the selected business entity. Alternatively, a wholesaler may be initially, selected.

The influence relationship can be a family relationship. The influence relationship can be ownership of a portion of the business entity. The influence relationship can be a direct non-family and non-ownership relationship with the business entity. The model graphically indicates a type of product that a retailer sells.

FINANCIAL RELATIONSHIP MODEL In a third embodiment, a financial relationship model can be generated by the following steps: generating a decision maker level including a decision maker; generating a business entity level including a business entity, wherein the business entity is linked to the decision maker; generating an entity owner level including an owner of a portion of the business entity; generating a financial organization level including a financial organization; generating and storing the model including the above levels; and performing at least one of the above generating steps with a computer. The order of the above steps may be varied, depending upon the focus of the modeler.

The financial organization can have a contractual relationship with the business entity. The contractual relationship can include at least one of the following: commodity loan, farm equipment loan, operation loan, and landlord lien.

FAMILY RELATIONSHIP MODEL In a fourth embodiment, a family relationship model can be generated by the following steps: generating a business entity level including a business entity; generating an entity owner level including an owner of a portion of the business entity; generating a family relationship level including a family relationship; generating and storing the model including the above levels; and performing at least one of the above generating steps with a computer. The order of the above steps may be varied, depending upon the focus of the modeler.

The family relationship can be a family relationship with the owner. The family relationship can be intestate succession. The priority a priority intestate succession can be indicated with a graphical indication. The graphical indication can utilize a thickness of a linking line to indicate a priority of the intestate succession family relationship. The family relationship level can include an icon with an area indicating a value of an operation metric associated with the business entity.

In the above embodiments, the model is generated by a series of steps, and at least one of the generation steps is performed with a computer. After generation, the model is stored in a computer storage memory. Further, the model can be used to perform real world analysis and decisions, such as targeting a selected decision maker for sale of a specific agricultural product. A pamphlet or written analysis can incorporate portions of the model and can be used as a sales tool.

Additional advantages and novel features will be set forth in part in the description which follows, and in part will become apparent to those skilled in the art upon examination of the following and the accompanying drawings or can be learned by production or operation of the examples. The advantages of the present teachings can be realized and attained by practice or use of the methodologies, instrumentalities and combinations particularly pointed out in the appended claims.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 is an exemplary operation model including the following levels: decision maker, business entity, entity ownership, acres operated, and crop distribution.

FIG. 2 is an exemplary influence model including the following levels: influence relationship (family, and non-family direct), and indirect influence relationship.

FIG. 3 is a legend for FIGS. 1, 2, and 4-6 illustrating the following coding: black shading for a target producer (for acreage operated by the target producer), diagonal lines for family relationships, and dots for direct non-family relationships. Colors can be used for coding.

FIG. 4 is an exemplary retail relationship model including the following levels: business entity, influence relationship (family, and non-family direct), retail sales relationship, and wholesale relationship.

FIG. 5 is an exemplary financial relationship model including the following levels: decision maker, business entity, entity ownership, and financial organization.

FIG. 6 is an exemplary family relationship model including the following levels: business entity, entity ownership, and family relationship.

FIG. 7 is a cover page of a first exemplary written analysis based on generated models.

FIG. 8 is page 2 of the first exemplary written analysis based on generated models.

FIG. 9 is page 3 of the first exemplary written analysis based on generated models.

FIG. 10 is page 4 of the first exemplary written analysis based on generated models.

FIG. 11 is page 5 of the first exemplary written analysis based on generated models.

FIG. 12 is page 6 of the first exemplary written analysis based on generated models.

FIG. 13 is page 7 of the first exemplary written analysis based on generated models.

FIG. 14 is page 8 of the first exemplary written analysis based on generated models.

FIG. 15 is page 9 of the first exemplary written analysis based on generated models.

FIG. 16 is page 10 of the first exemplary written analysis based on generated models.

FIG. 17 is page 11 of the first exemplary written analysis based on generated models.

FIG. 18 is page 12 of the first exemplary written analysis based on generated models.

FIG. 19 is page 13 of the first exemplary written analysis based on generated models.

FIG. 20 is page 14 of the first exemplary written analysis based on generated models.

FIG. 21 is page 15 of the first exemplary written analysis based on generated models.

FIG. 22 is page 16 of the first exemplary written analysis based on generated models.

FIG. 23 is page 17 of the first exemplary written analysis based on generated models.

FIG. 24 is page 18 of the first exemplary written analysis based on generated models.

FIG. 25 is page 19 of the first exemplary written analysis based on generated models.

FIG. 26 is page 20 of the first exemplary written analysis based on generated models.

FIG. 27 is page 21 of the first exemplary written analysis based on generated models.

FIG. 28 is page 22 of the first exemplary written analysis based on generated models.

FIG. 29 is page 23 of the first exemplary written analysis based on generated models.

FIG. 30 is page 24 of the first exemplary written analysis based on generated models.

FIG. 31 is page 25 of the first exemplary written analysis based on generated models.

FIG. 32 is page 26 of the first exemplary written analysis based on generated models.

FIG. 33 is page 27 of the first exemplary written analysis based on generated models.

FIG. 34 is page 28 of the first exemplary written analysis based on generated models.

FIG. 35 is page 29 of the first exemplary written analysis based on generated models.

FIG. 36 is page 30 of the first exemplary written analysis based on generated models.

FIG. 37 is page 31 of the first exemplary written analysis based on generated models.

FIG. 38 is a cover page of a second exemplary written analysis based on generated models.

FIG. 39 is page 1 of the second exemplary written analysis based on generated models.

FIG. 40 is page 2 of the second exemplary written analysis based on generated models.

FIG. 41 is page 3 of the second exemplary written analysis based on generated models.

FIG. 42 is page 4 of the second exemplary written analysis based on generated models.

FIG. 43 is page 5 of the second exemplary written analysis based on generated models.

FIG. 44 is page 6 of the second exemplary written analysis based on generated models.

FIG. 45 is page 7 of the second exemplary written analysis based on generated models.

FIG. 46 is page 8 of the second exemplary written analysis based on generated models.

FIG. 47 is page 9 of the second exemplary written analysis based on generated models.

FIG. 48 is page 10 of the second exemplary written analysis based on generated models.

FIG. 49 is page 11 of the second exemplary written analysis based on generated models.

FIG. 50 is page 12 of the second exemplary written analysis based on generated models.

FIG. 51 is page 13 of the second exemplary written analysis based on generated models.

FIG. 52 is page 14 of the second exemplary written analysis based on generated models.

FIG. 53 is page 15 of the second exemplary written analysis based on generated models.

FIG. 54 is page 16 of the second exemplary written analysis based on generated models.

FIG. 55 is page 17 of the second exemplary written analysis based on generated models.

FIG. 56 is page 18 of the second exemplary written analysis based on generated models.

FIG. 57 is page 19 of the second exemplary written analysis based on generated models.

FIG. 58 is page 20 of the second exemplary written analysis based on generated models.

FIG. 59 is page 21 of the second exemplary written analysis based on generated models.

FIG. 60 is page 22 of the second exemplary written analysis based on generated models.

FIG. 61 is page 23 of the second exemplary written analysis based on generated models.

### DETAILED DESCRIPTION OF THE DRAWINGS

In the following detailed description, numerous specific details are set forth by way of examples in order to provide a thorough understanding of the relevant teachings. However, it should be apparent to those skilled in the art that the present teachings can be practiced without such details. In other instances, well known methods, procedures, components, and circuitry have been described at a relatively high-level, without detail, in order to avoid unnecessarily obscuring aspects of the present teachings.

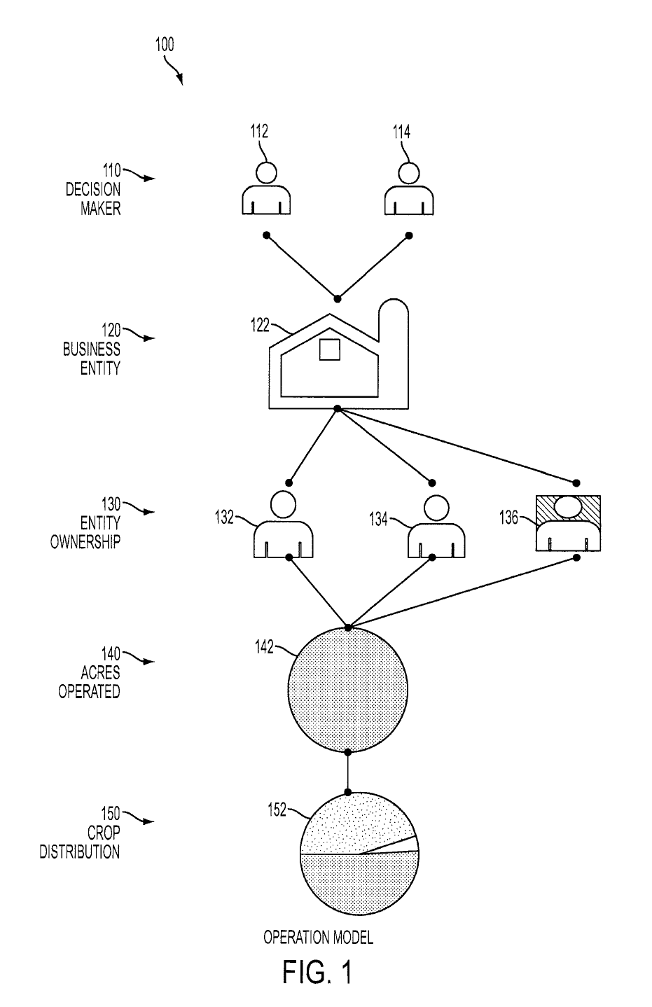

FIG. 1 is an exemplary operation model 100 including the following levels: decision maker level 110, business entity level 120, entity ownership level 130, acres operated level 140, and crop distribution level 150.

DECISION MAKER LEVEL. The levels can be hierarchical. For example, the first level is decision maker level 110. One or more decision makers 112 and 114 (also known as key persons, or as target individuals) can be selected for modeling, and can serve as the “top” level or main level in a hierarchical model. The decision maker can be an officer of public record for a business entity such as a corporation or a partnership or a sole proprietorship. The officer can be a president or vice-president or secretary (depending upon the state of incorporation of the business entity), or can be a member of the board of directors of the business entity. The decision maker can have a more complex formal or informal relationship, such as a court appointed administrator (for a business undergoing bankruptcy), or perhaps a dominant father of a relatively young legal owner.

BUSINESS ENTITY LEVEL. The second level is business entity level 120, including one or more business entities 122 for which decisions are made by the decision maker. In one

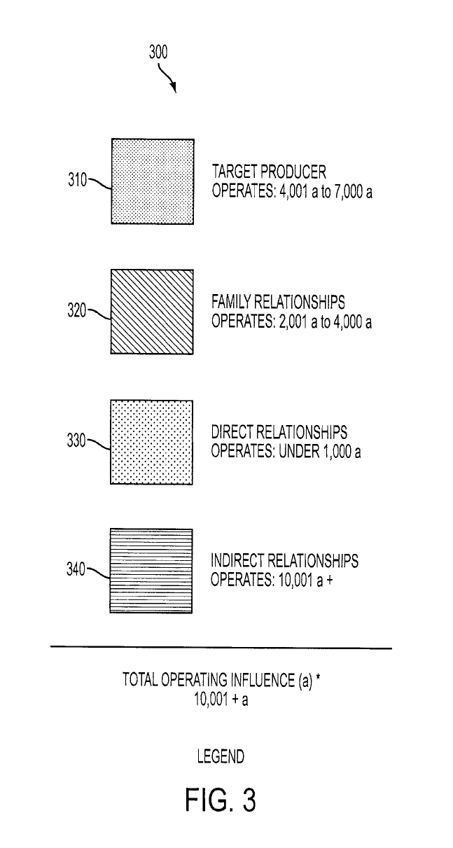

ENTITY OWNERSHIP LEVEL. The third level is entity ownership level 130, including one or more owners 132, 134, and 136. Owner 132 can be the same person as decision maker 112. The icon for owner 136 has diagonal lines, which indicates a family relationship with at least one of the decision makers (see FIG. 3 regarding shading with diagonal lines). For example, owner 136 can be a brother of decision maker 112. Color can also be used to indicate types of family relationship. Connecting lines can be used to indicate the type of family relationship. Family relationships can be defined based upon the intestate (without a will) succession rules of inheritance.

In a first example, these family relationships can be defined based upon the relationship of the entity owner with respect to a key decision maker. For example, decision maker 112 can be a dominant father who has already given ownership to his children (perhaps including entity owner 136), but can maintain substantial control of business entity through being chairman of the board of directors, or by other informal means. In this case, the intestate succession rules of inheritance are used merely as a convenient or default method of evaluating/ranking the strength of a family relationship, and this type of ranking can be graphically illustrated by color, by the width of the connecting line, or by other graphical methods.

In a second example of intestate family relationships, the family relationships can be defined based on the dominant entity owner (the owner who owns the largest amount of the business entity). In this case, the intestate rules of the state of residence of the dominant entity owner can be used.

ACRES OPERATED LEVEL. The fourth level is acres operated level 140 (for a farm), or can be tons of fertilizer produced for a fertilizer plant, or whatever production metric is convenient for the business entity 122. The number of acres operated can be illustrated by the diameter or area of an icon 142, or by color. The fourth level can also indicate the acres controlled, even if not all of the acres are operated.

The fourth level can indicate acres operated by the business entities of level 120. The fourth level can be expanded to include all acres operated by each of the entity owners of level 130, which can include acres from other business entities. Other metrics can be appropriate for other types of business.

CROP DISTRIBUTION LEVEL. The fifth level is crop distribution level 150. The fifth level can be a pie chart 152 with separate segments of the pie indicating the amount of acres dedicated to each crop. Other metrics can be appropriate for other types of business.

Alternatively (and importantly), the operational model can begin by targeting one or more business entities, such as business entity 122. In this case, business entity level 120 serves as the top hierarchical level (or logical level), even if the model is displayed as shown in FIG. 1 for convenience. In this case, decision maker level 110 and entity ownership level 130 would logically depend from (and logically be one level “down” from) business entity level 120.

Another way of describing/interpreting this alternative is that the target business entity 122 is at the center of the analysis, and the decision makers 112 and 114 and the entity owners 132, 134, and 136 radiate outward from the center. In other words, the hierarchical “levels” can be graphed as outwardly expanding concentric circles, with the decision makers and the entity owners at the first outer concentric circle.

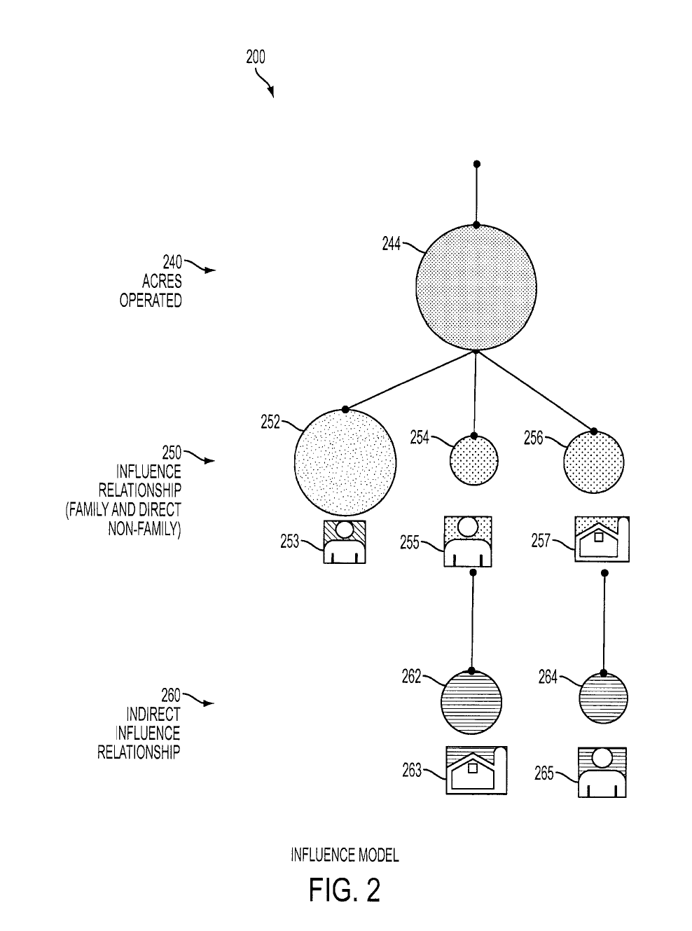

FIG. 2 is an exemplary influence model 200 including the following levels: influence relationship (family, and non-family direct), and indirect influence relationship. These relationships in FIG. 2 indicate acres not directly or legally controlled by business entity 120, but somehow influenced by business entities of level 120 or by entity owners of level 130 of FIG. 1.

In FIG. 2, influence relationship level 250 depends from acres operated level 240. Influence relationship level 250 comprises family relationships and direct non-family relationships. Alternatively, influence relationship level 250 can depend from decision maker level 110, or from entity ownership level 130, or from a combination of decision maker level 110 and entity ownership level 130.

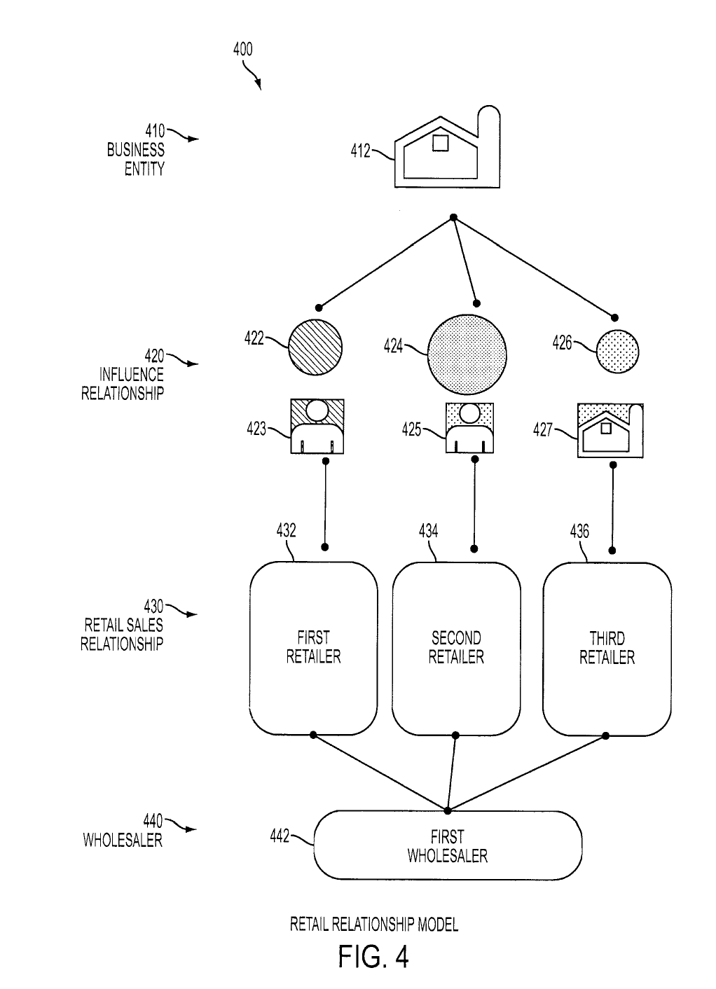

Large circle 252 indicates that a large number of acres (large amount of land) is influenced by family member 253. Family member 253 can be a relative of a decision maker, or a relative of an owner. See FIG. 4 for a legend regarding shading. Small circle 254 indicates that a small number of acres are directly influenced by non-family member 255. Non-family member 255 can be in a partnership with decision maker 112. Medium circle 256 indicates that a medium number of acres are directly influenced by non-family member 257 (a living trust).

Also in FIG. 2, indirect influence level 260 indicates indirect relationships. Medium circle 262 indicates that a medium number of acres are controlled by living trust 263 which is associated with non-family member 255. Circle 264 indicates that a small number of acres are controlled by person 265 who is associated with living trust 257.

FIG. 3 is a legend 300 for FIGS. 1, 2, and 4-6 illustrating the following coding: solid black shading 310 for a target producer (an entity of interest such as a farm), diagonal lines 320 for family relationships, dots 330 for direct non-family relationships, and horizontal lines 340 for indirect relationships. Alternatively or additionally, colors can be used for coding. The legend conveniently indicates the acres operated for the target producer, for each type of relationship, and the total acres influenced.

FIG. 4 is an exemplary retail relationship model 400 including the following levels: business entity level 410, influence relationship level 420 (family, and non-family direct), retail sales relationship level 430, and wholesaler relationship level 440.

Business entity level 410 comprises business entity 412.

Influence relationship level 420 includes: medium circle 422 with diagonal lines indicating that person 423 is a family member controlling a medium number of acres; large black circle 424, indicating that a large number of acres are directly controlled by business entity 412 and by person 425; and small circle 426 with dots indicting that living trust 427 has direct influence on a small number of acres.

Retail sales relationships level 430 includes: a first retailer 432, second retailer 434, and a third retailer 436. These retailers can be cooperatives, or other intermediary legal structures. Each of these retailers is associated with at least one of the entities of influence relationships level 420.

Wholesaler level 440 includes at least a first wholesaler 442, and this first wholesaler 442 is associated with at least one retailer of retail sales relationship level 430.

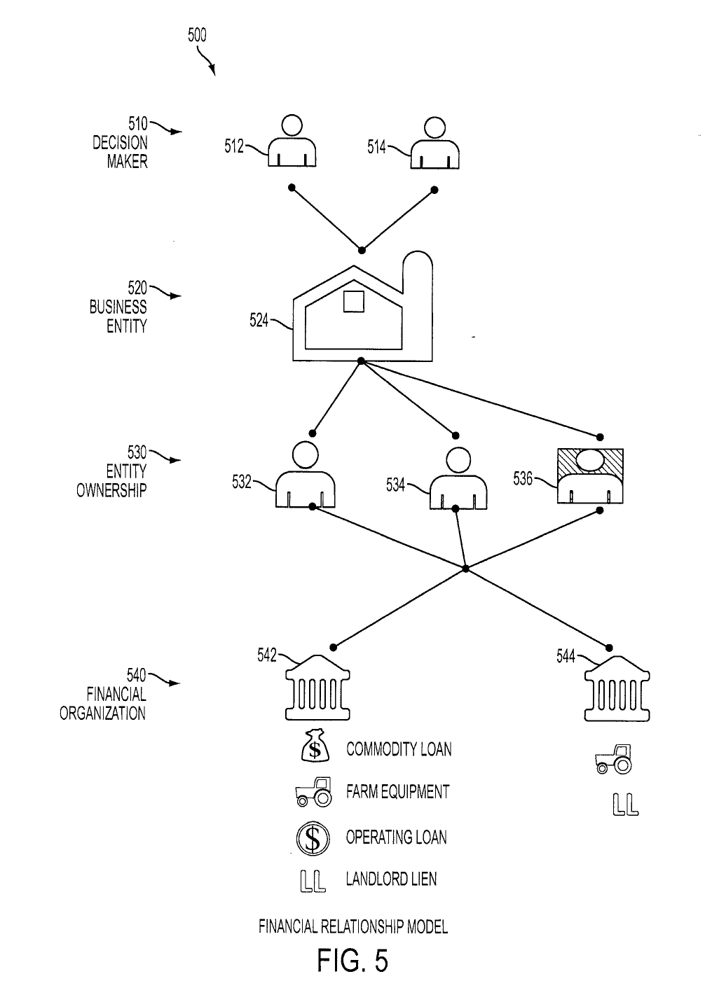

FIG. 5 is an exemplary financial relationship model including the following levels: decision maker level 510 can include decision makers 512 and 514; business entity level 520 can include business entity 524; entity ownership level 530 can include owners 532, 534, and 536; and financial organization level 540 can include financial organizations 542 and 544.

The top three levels of FIG. 5 are similar to the top three levels of FIG. 1. The fourth level of FIG. 5 is financial organization level 540, including financial organization 542 and financial organization 544.

These financial organizations can be linked directly to business 524, or can be linked directly to owners 532, 534, and 536 (if the owners co-signed or guaranteed loans to business 524). Financial organization 542 can be a bank that provided a commodity loan, a farm equipment loan, an operating loan, and can also hold a landlord lien.

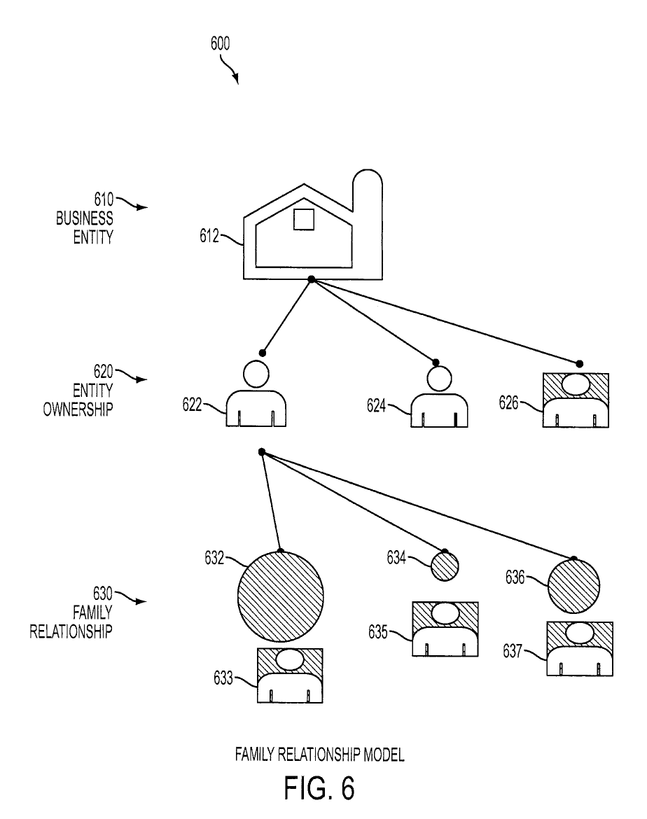

FIG. 6 is an exemplary family relationship model 600 including the following levels: business entity level 610 can include business entity 612; entity ownership level 620 can include owners 622, 624, and 626; and family relationship level 630 can include family members 633, 635, and 637, as well as related metric icons (circles in this example) 632, 634, and 636.

The top two levels of FIG. 6 are similar to the top two levels of FIG. 1. The third level of FIG. 6 is family relationship level 630.

Family relationship level 630 includes: large circle 632 with diagonal lines indicating that person 633 is a family member associated with a large number of acres; small circle 634 with diagonal lines indicates that person 635 is a family member associated with a small number of acres, and medium circle 636 with diagonal lines indicates that person 637 is a family member associated with a small number of acres.

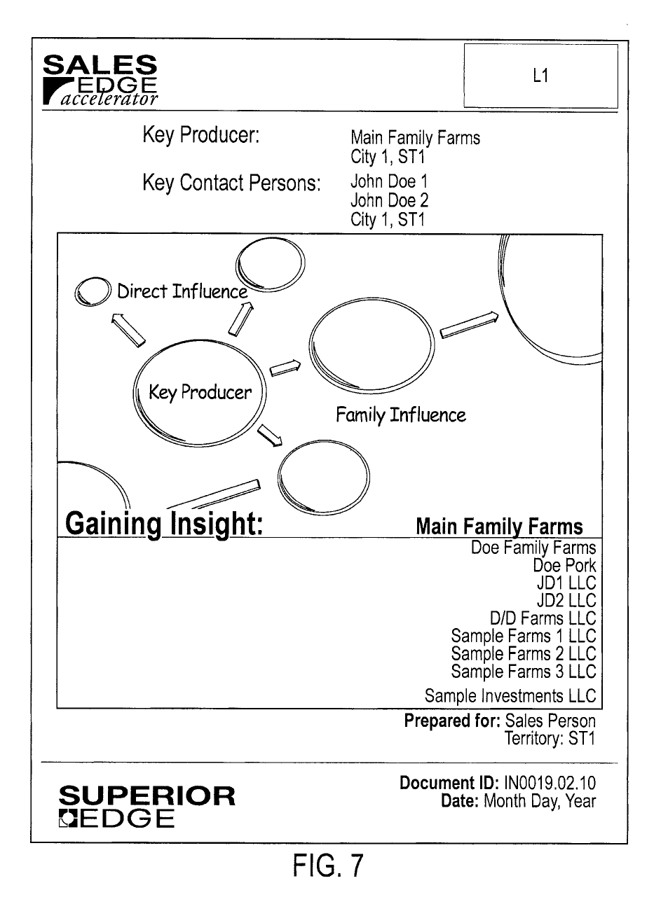

FIGS. 7-37 are pages from a first exemplary written analysis based on generated models. These FIGS. are discussed in more detail below.

FIG. 7 is a cover page of the first exemplary written analysis based on generated models. The cover page includes a title and contact information.

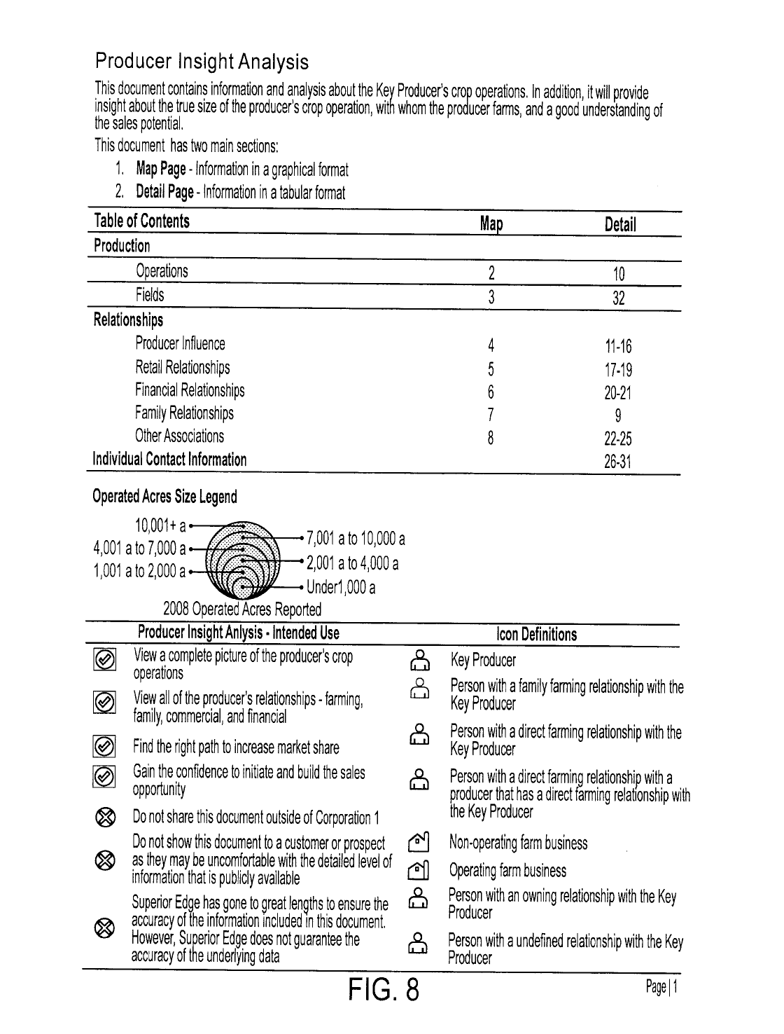

FIG. 8 is page 1 of the first exemplary written analysis based on generated models, and includes a table of contents and icon definitions.

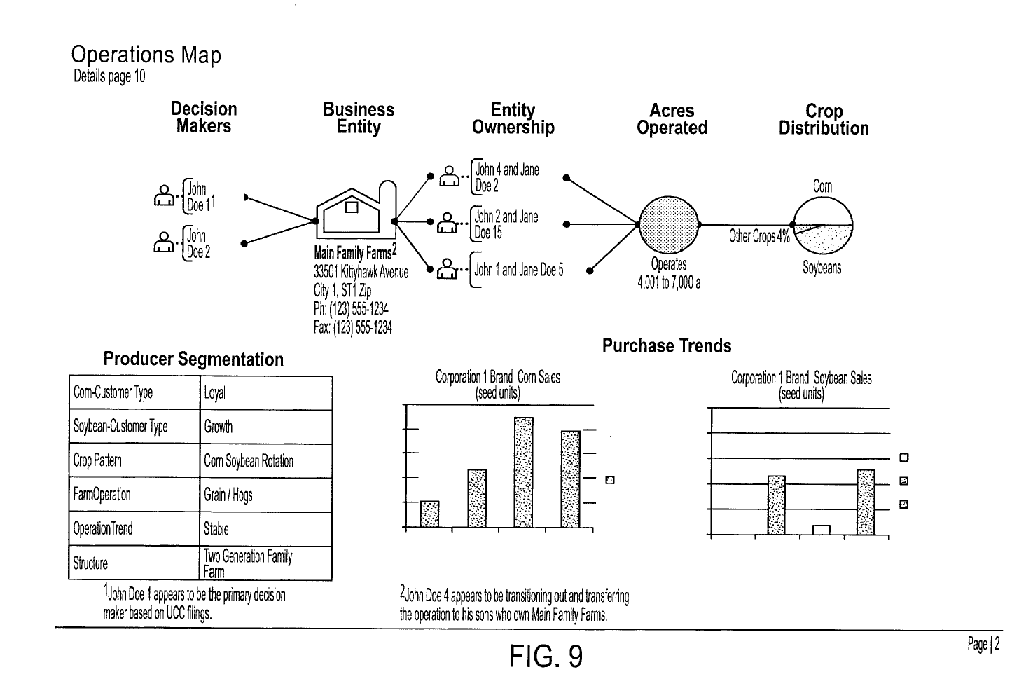

FIG. 9 is page 2 of the first exemplary written analysis based on generated models, and includes an operation map, producer segmentation, and purchase trends. In this context, the term “map” may be used instead of the more technical term “model,” in order to facilitate understanding by a user.

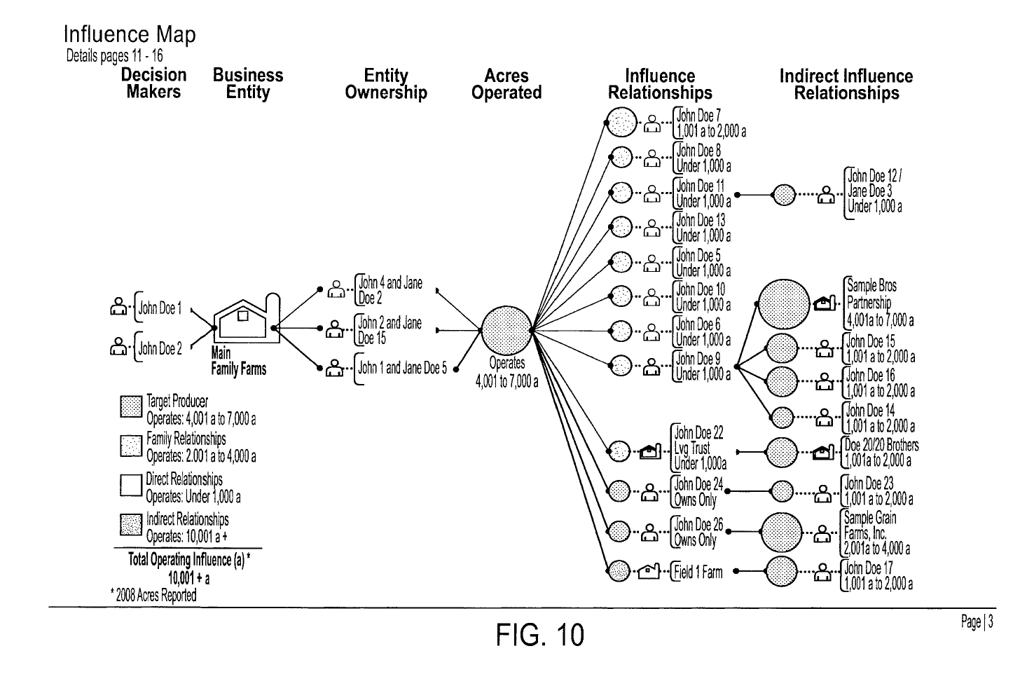

FIG. 10 is page 3 of the first exemplary written analysis based on generated models, and includes

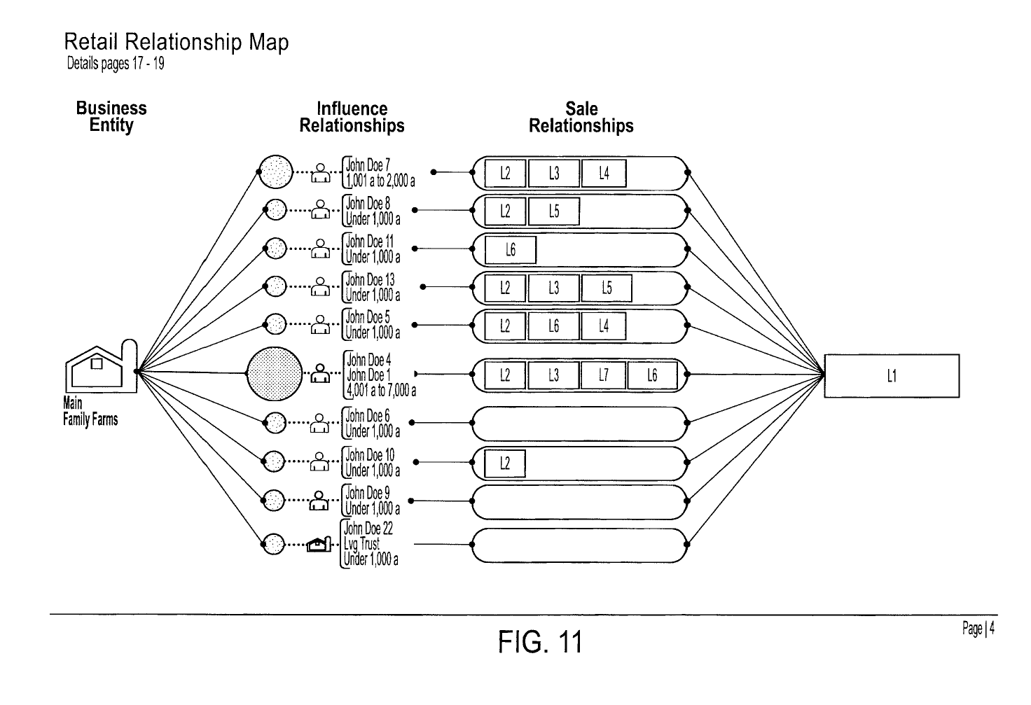

FIG. 11 is page 4 of the first exemplary written analysis based on generated models, and includes

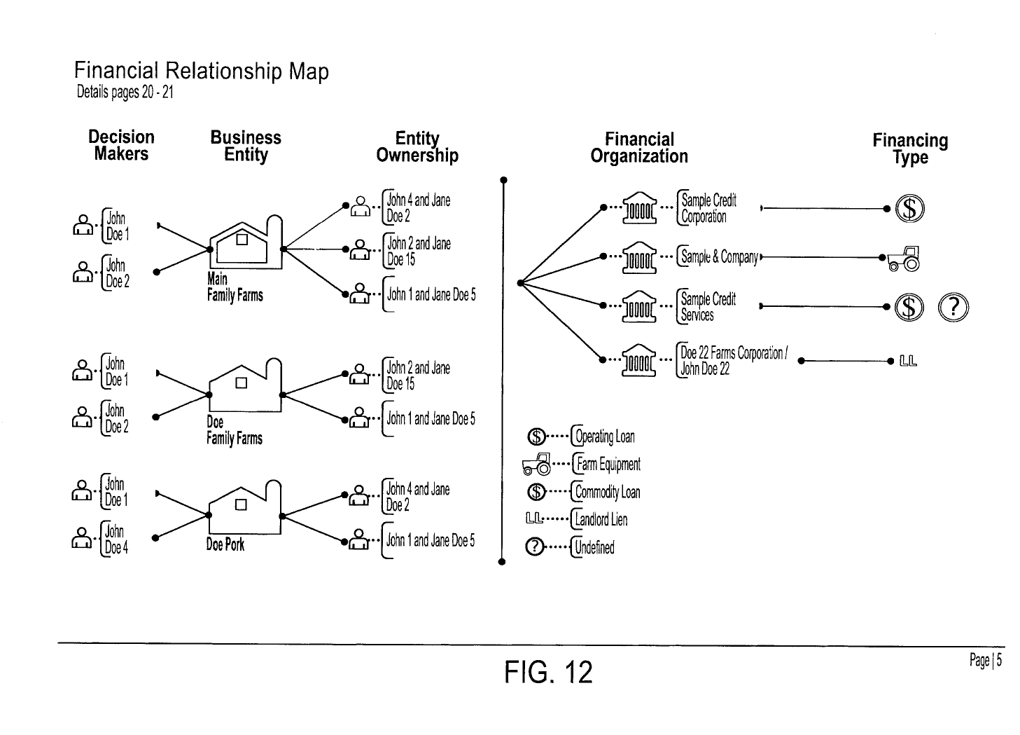

FIG. 12 is page 5 of the first exemplary written analysis based on generated models, and includes

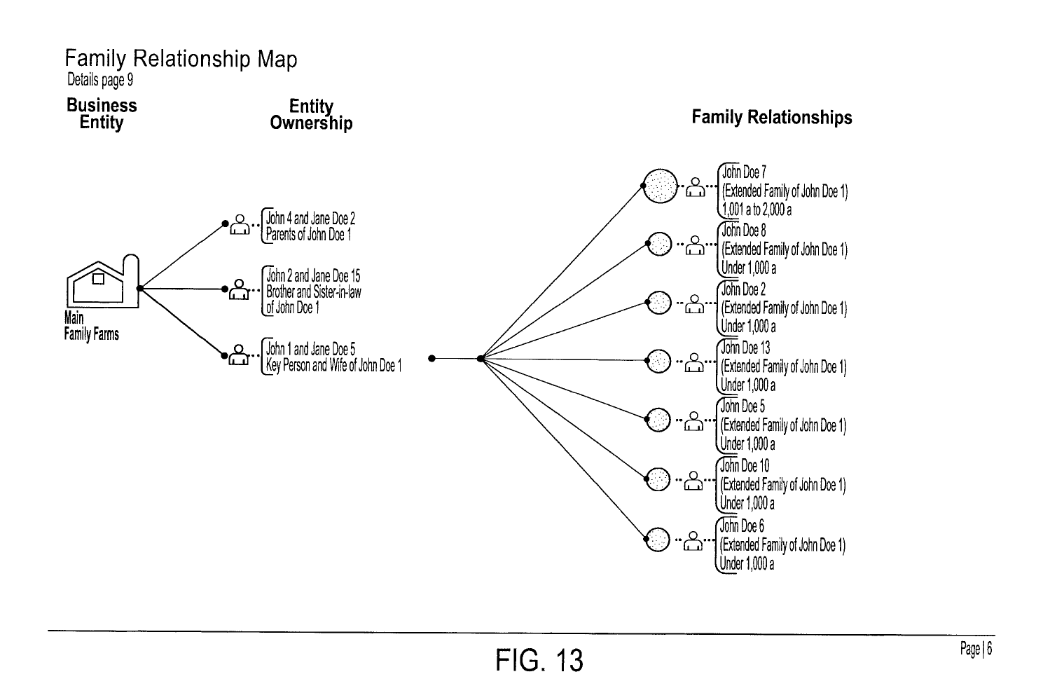

FIG. 13 is page 6 of the first exemplary written analysis based on generated models, and includes

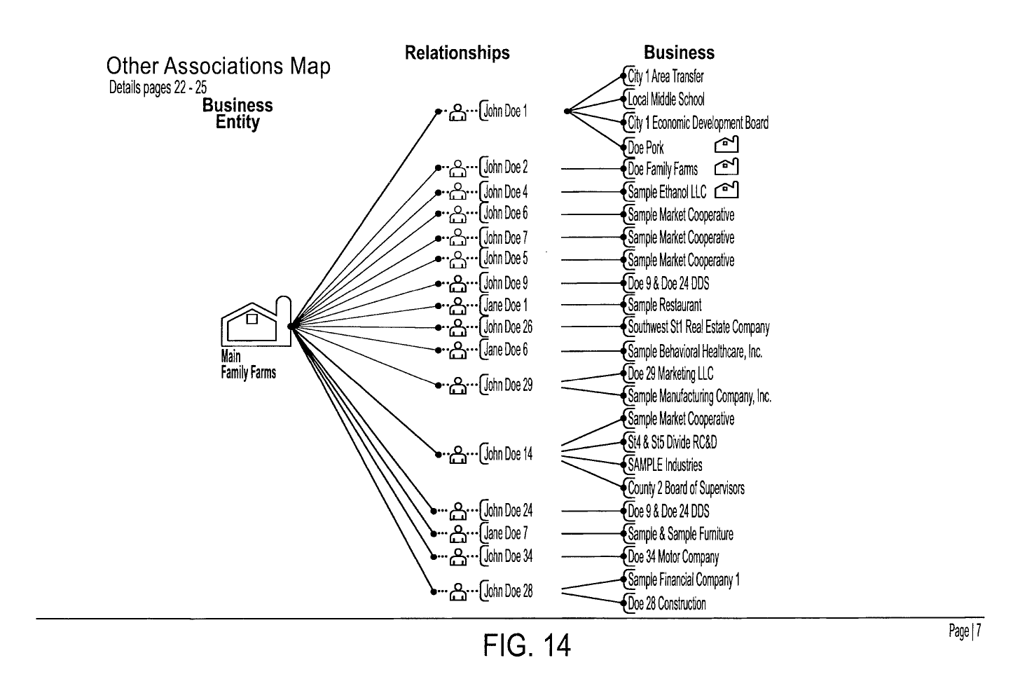

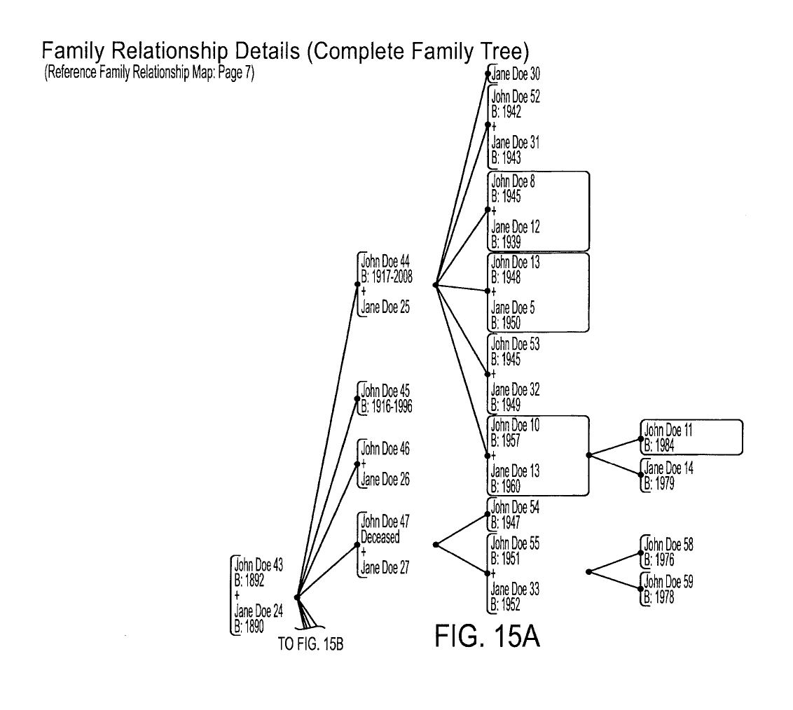

FIG. 14 is page 7 of the first exemplary written analysis based on generated models, and includes

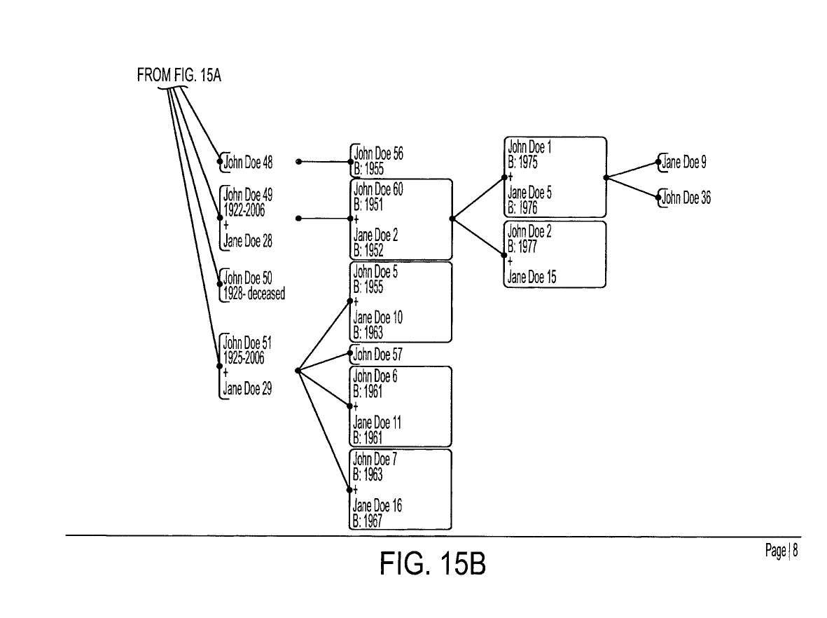

FIG. 15 is page 8 of the first exemplary written analysis based on generated models, and includes

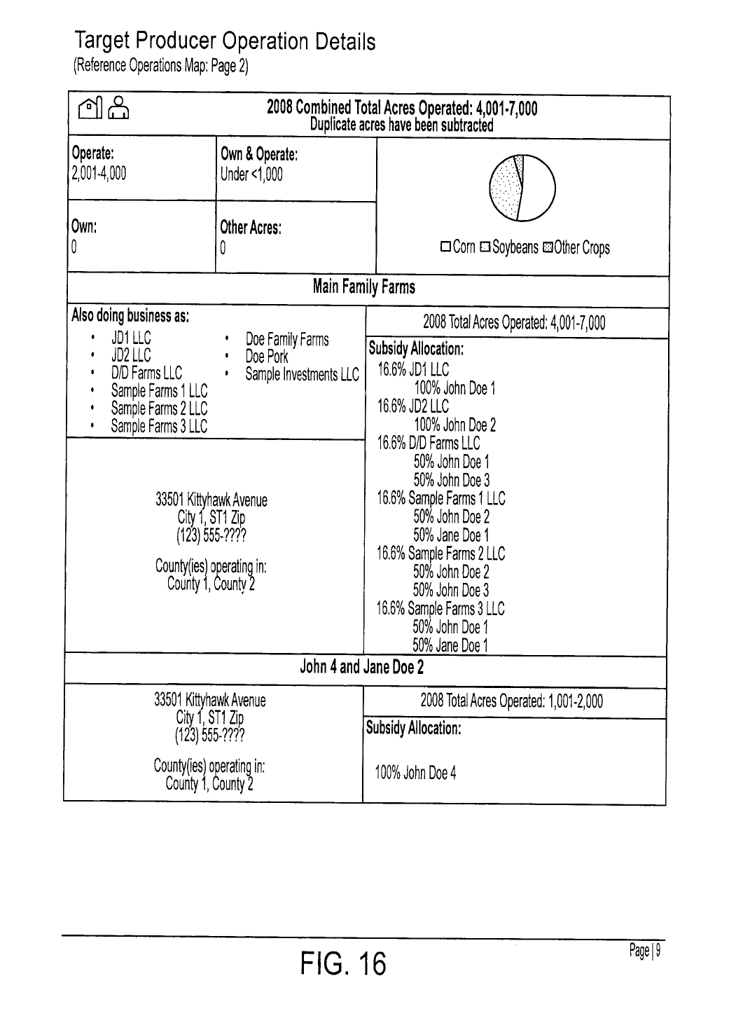

FIG. 16 is page 9 of the first exemplary written analysis based on generated models, and includes

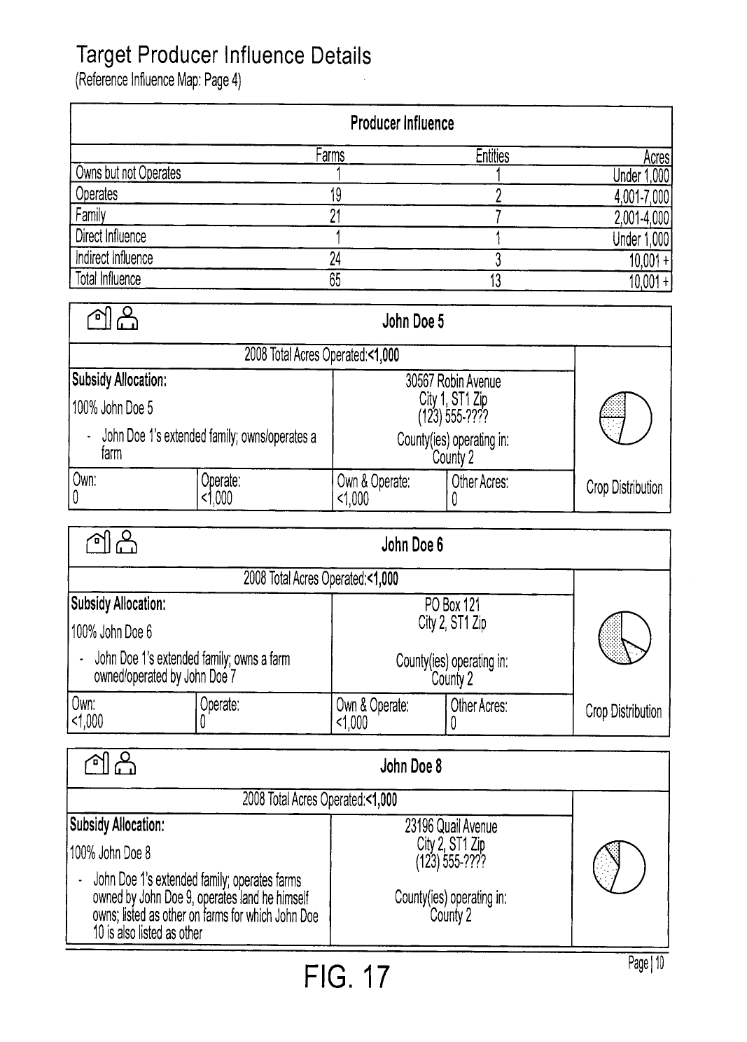

FIG. 17 is page 10 of the first exemplary written analysis based on generated models, and includes

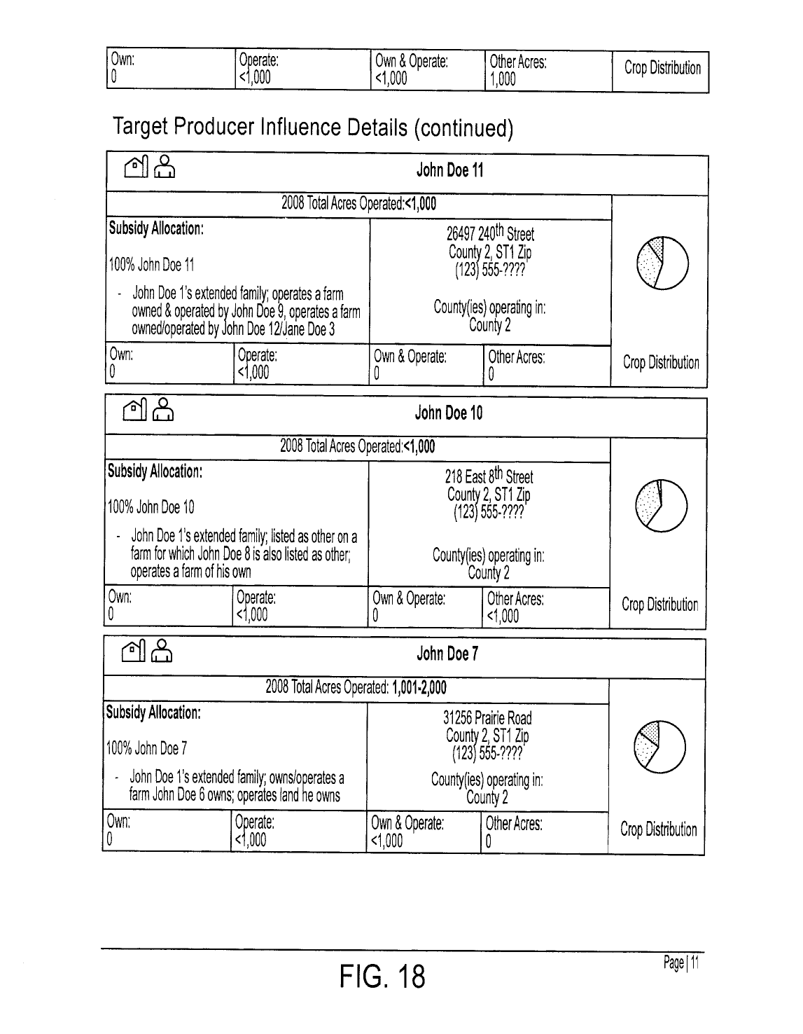

FIG. 18 is page 11 of the first exemplary written analysis based on generated models, and includes

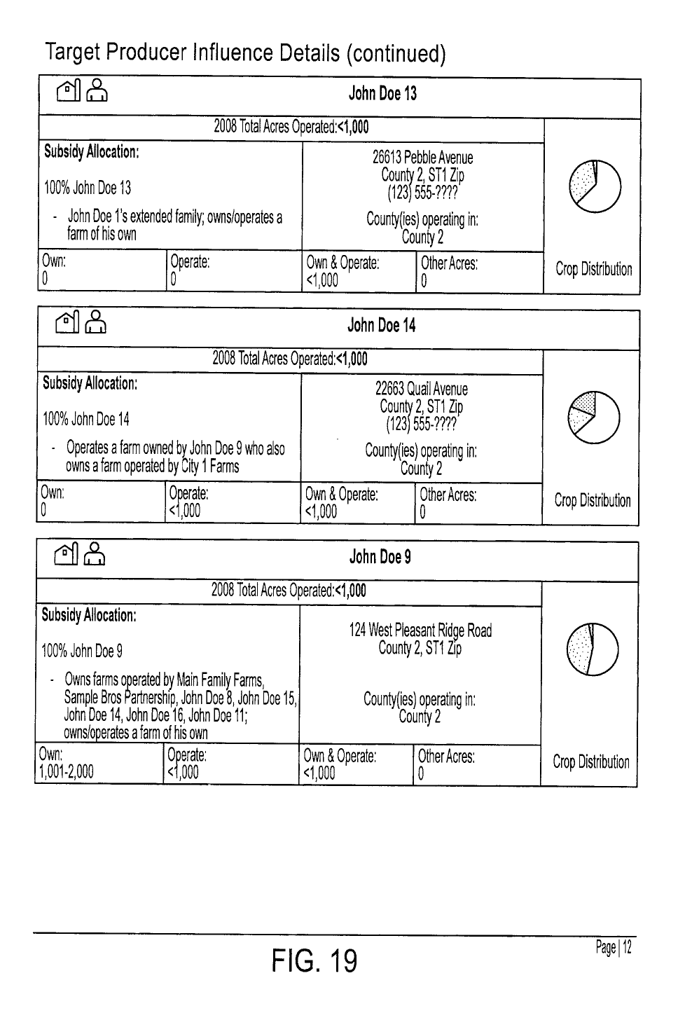

FIG. 19 is page 12 of the first exemplary written analysis based on generated models, and includes

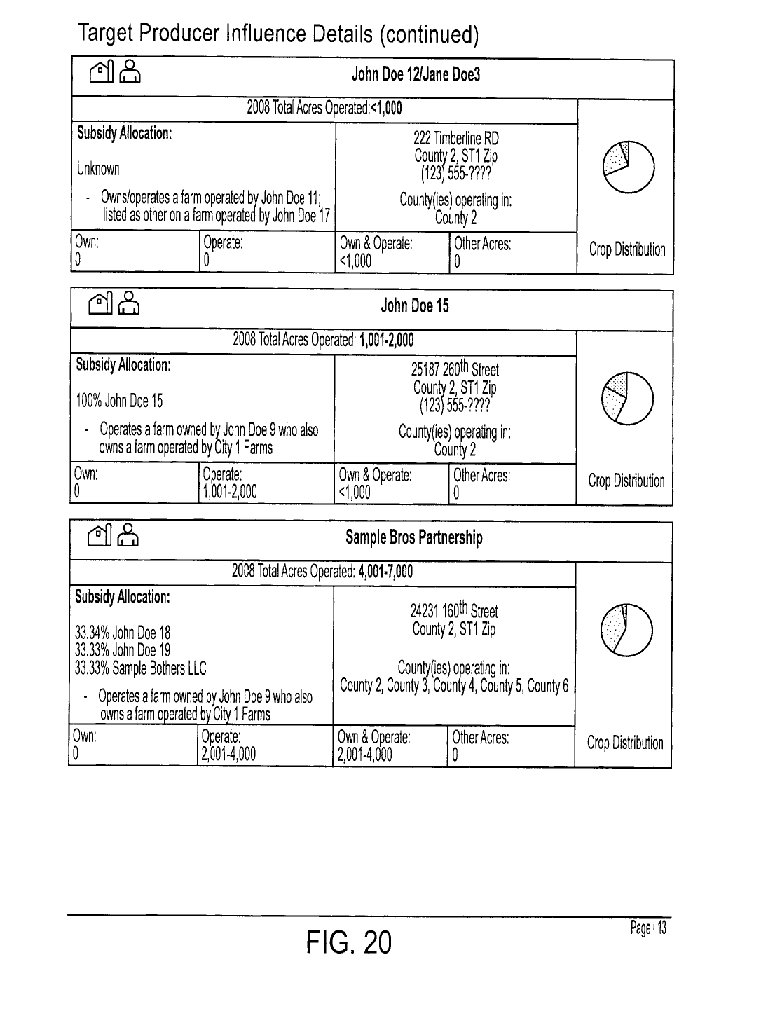

FIG. 20 is page 13 of the first exemplary written analysis based on generated models, and includes

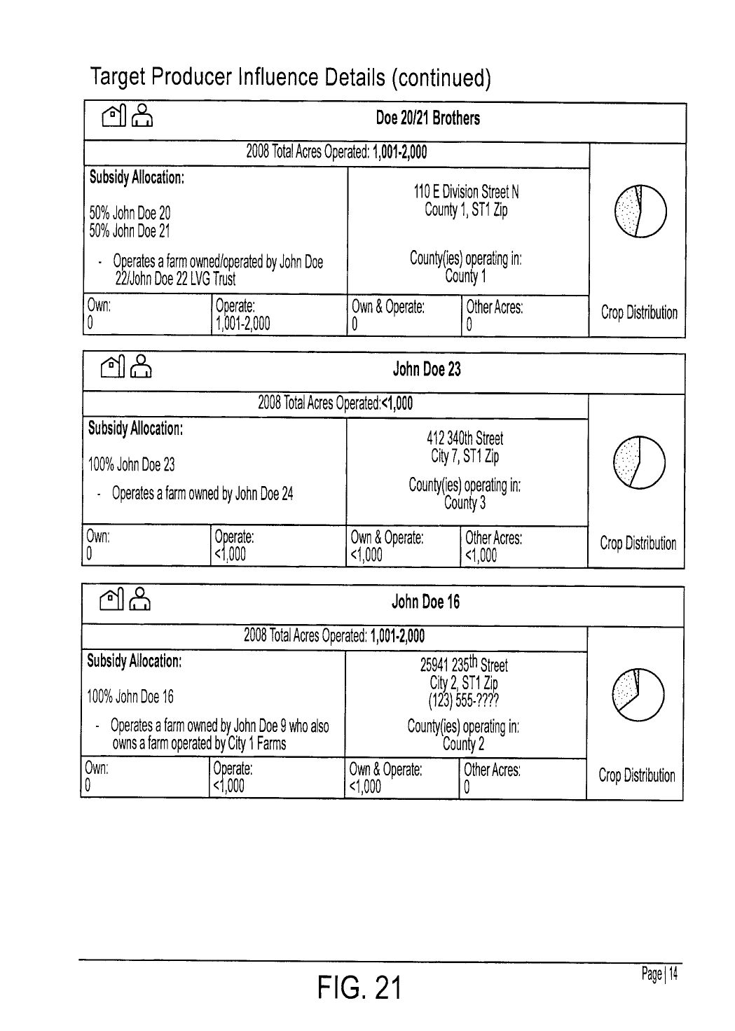

FIG. 21 is page 14 of the first exemplary written analysis based on generated models, and includes

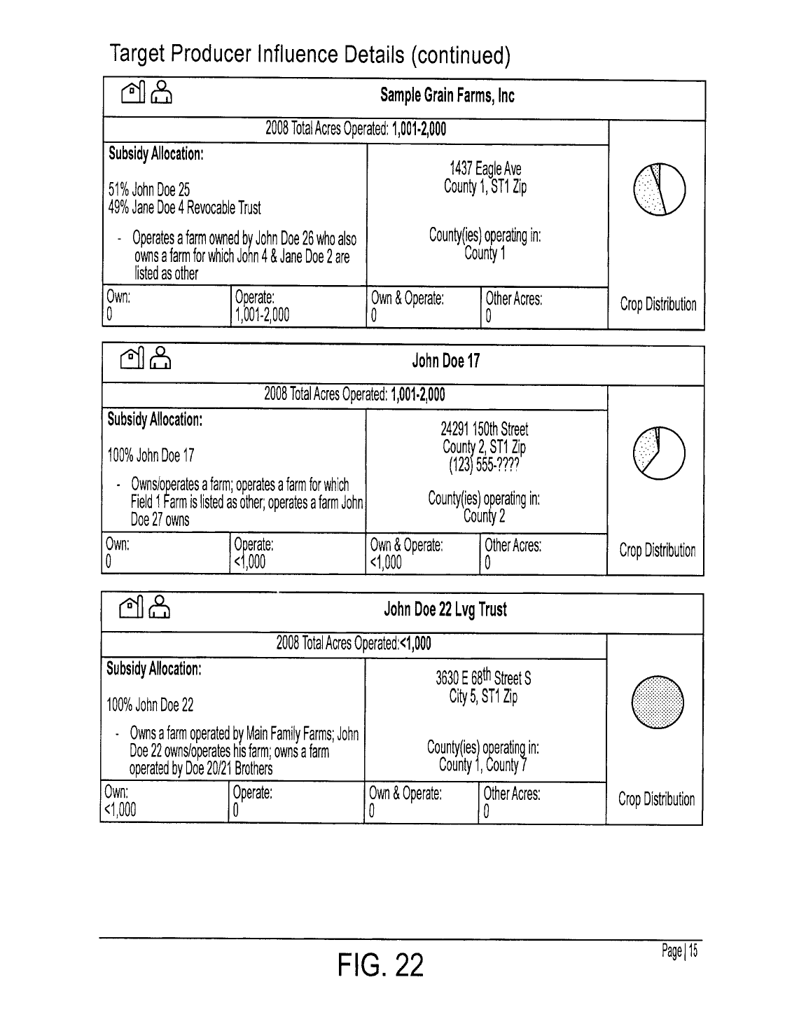

FIG. 22 is page 15 of the first exemplary written analysis based on generated models, and includes

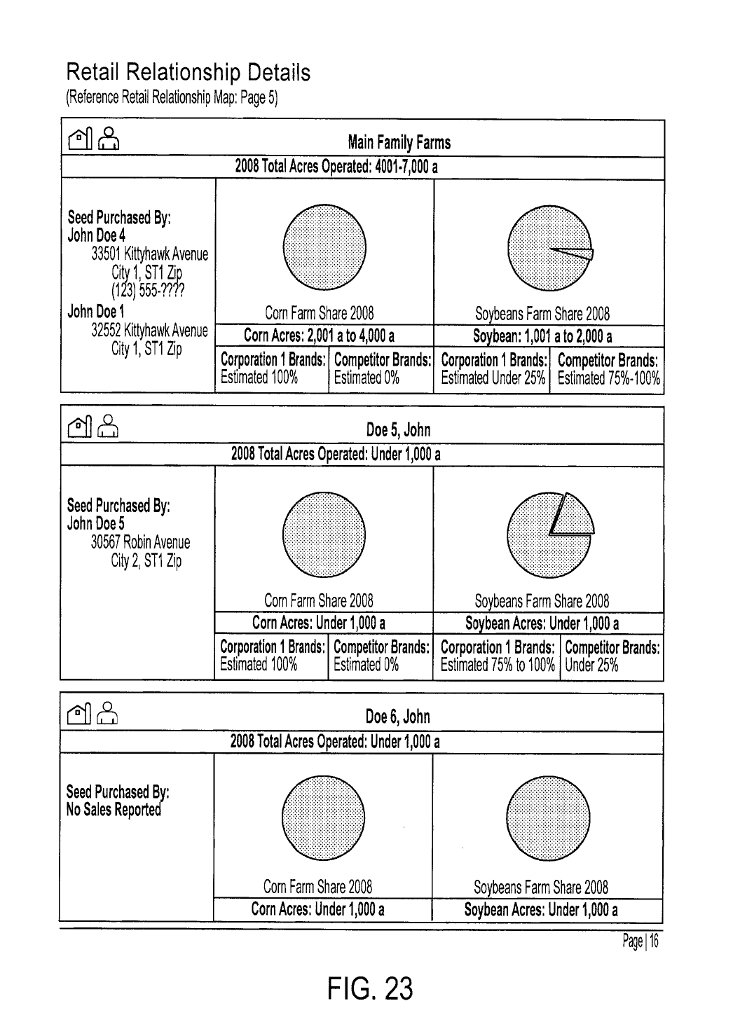

FIG. 23 is page 16 of the first exemplary written analysis based on generated models, and includes

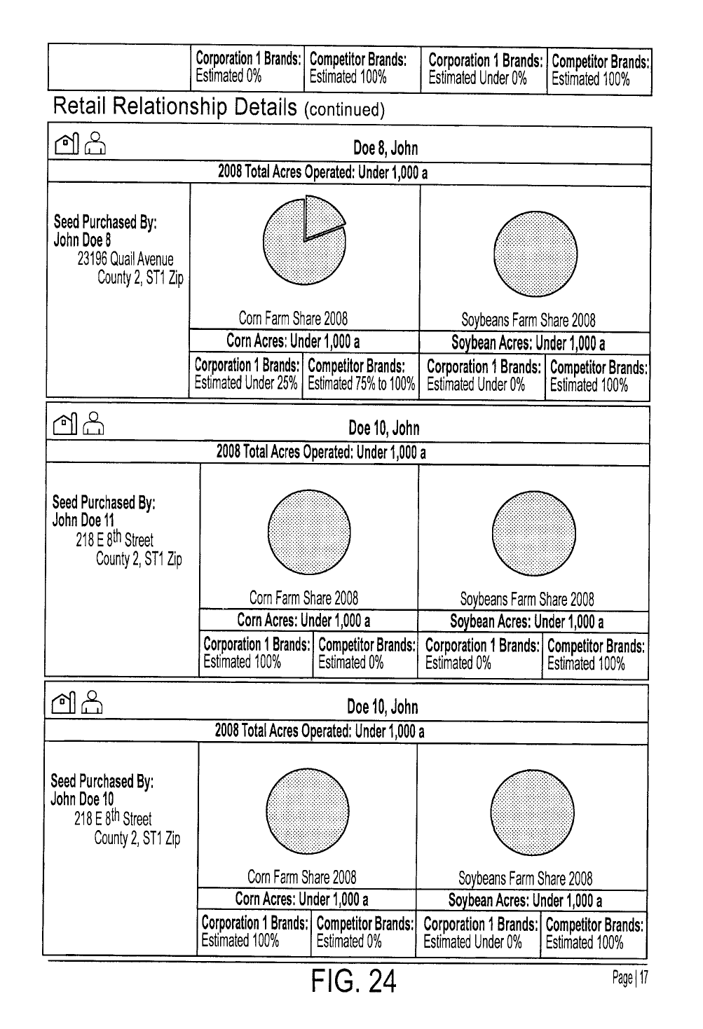

FIG. 24 is page 17 of the first exemplary written analysis based on generated models, and includes

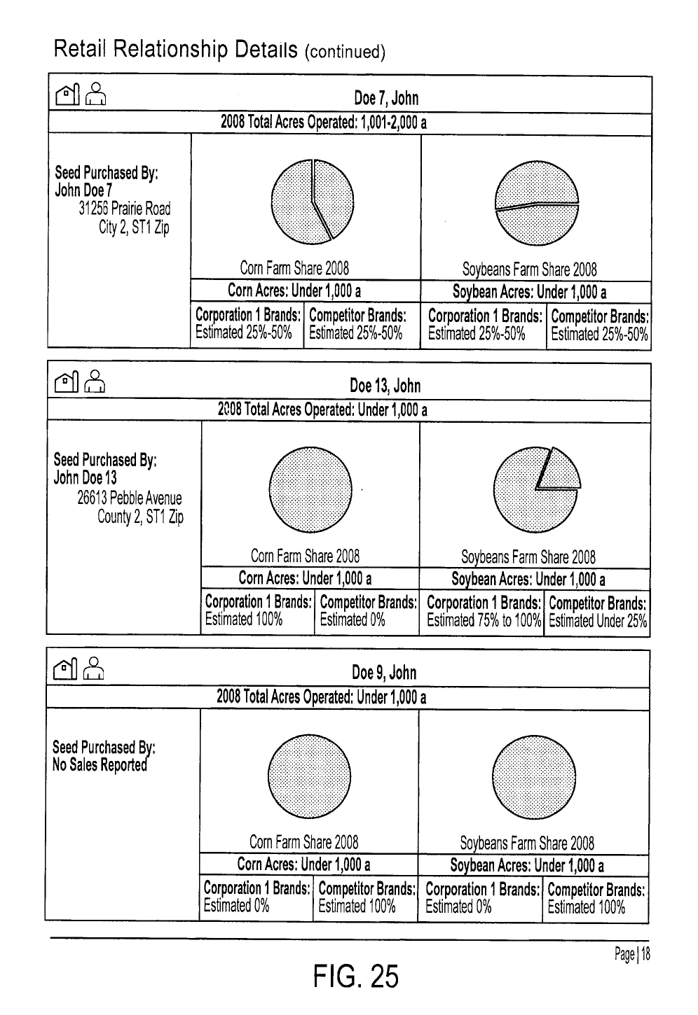

FIG. 25 is page 18 of the first exemplary written analysis based on generated models, and includes

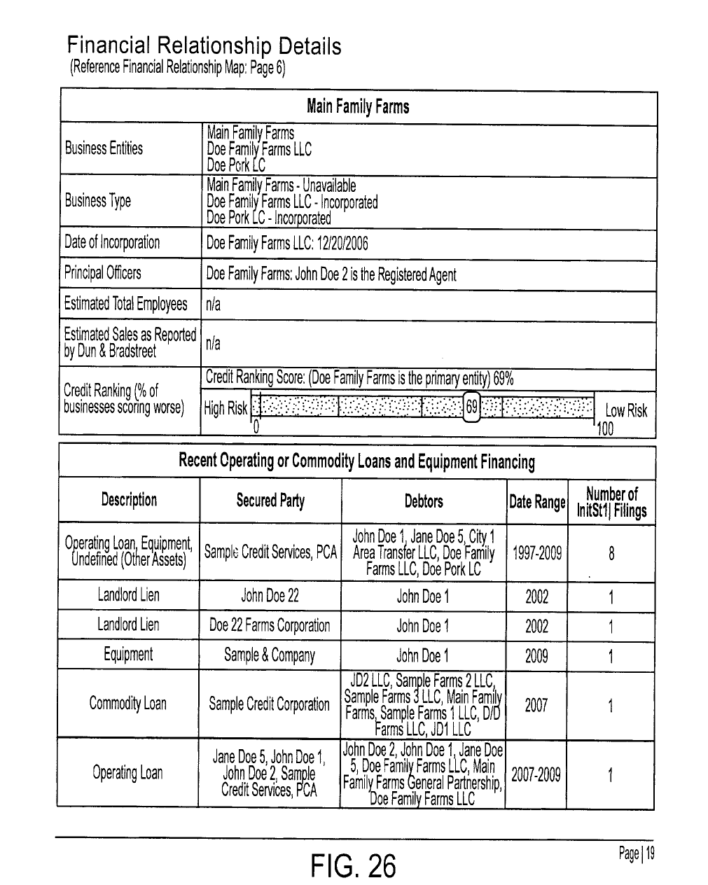

FIG. 26 is page 19 of the first exemplary written analysis based on generated models, and includes

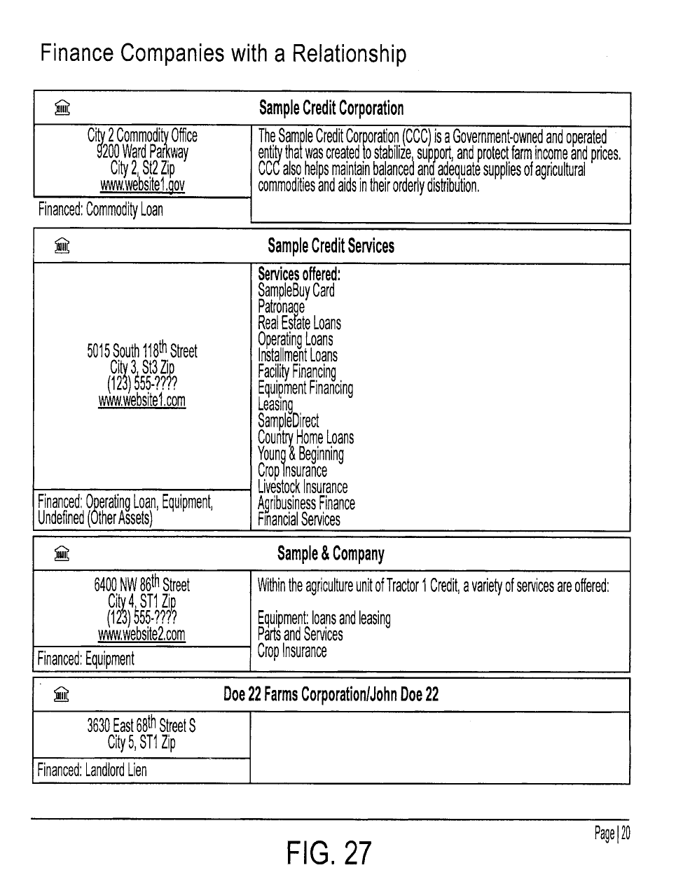

FIG. 27 is page 20 of the first exemplary written analysis based on generated models, and includes

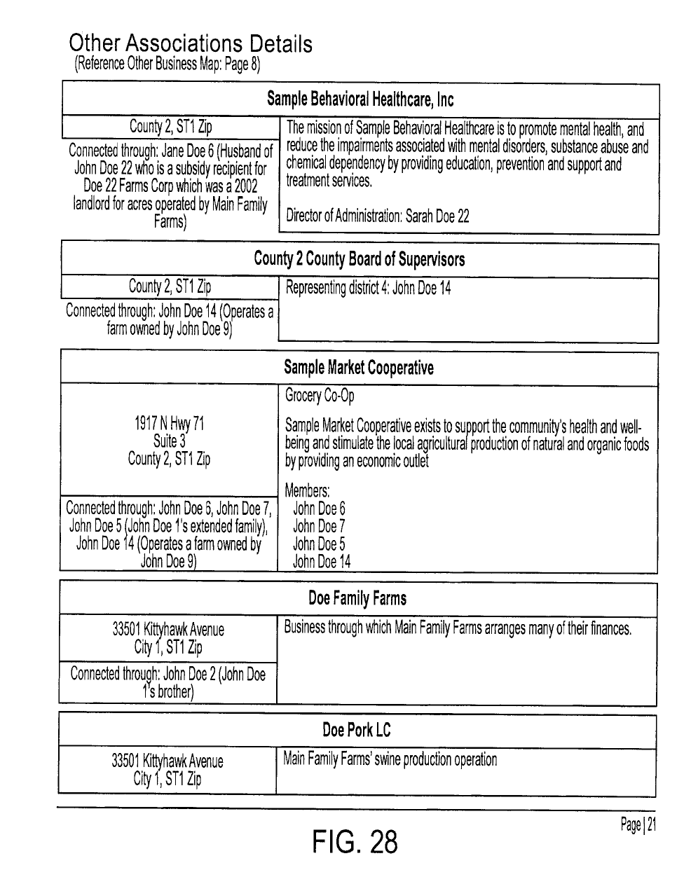

FIG. 28 is page 21 of the first exemplary written analysis based on generated models, and includes

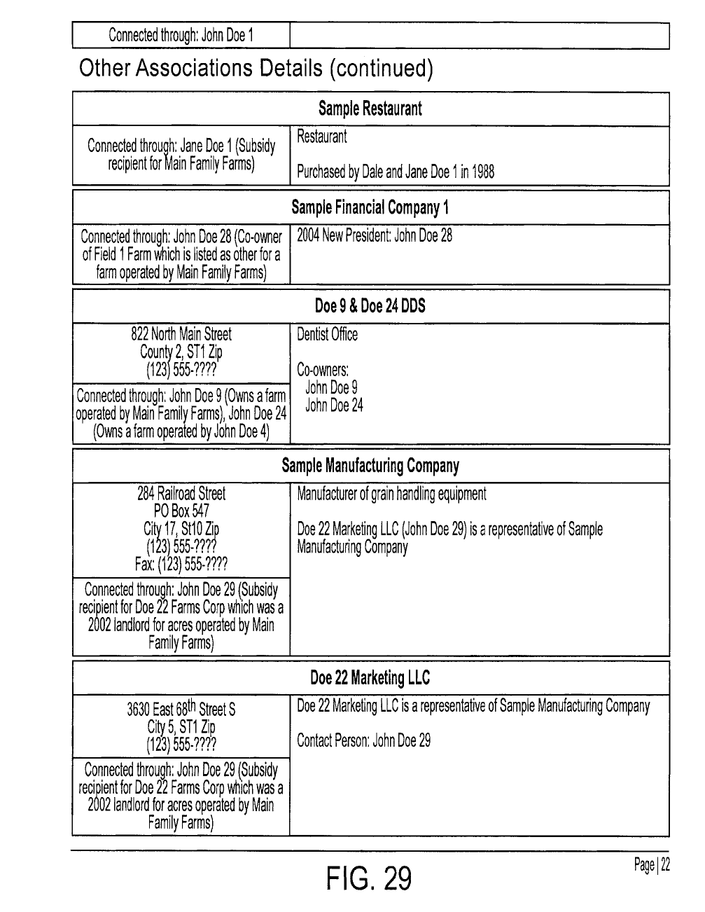

FIG. 29 is page 22 of the first exemplary written analysis based on generated models, and includes

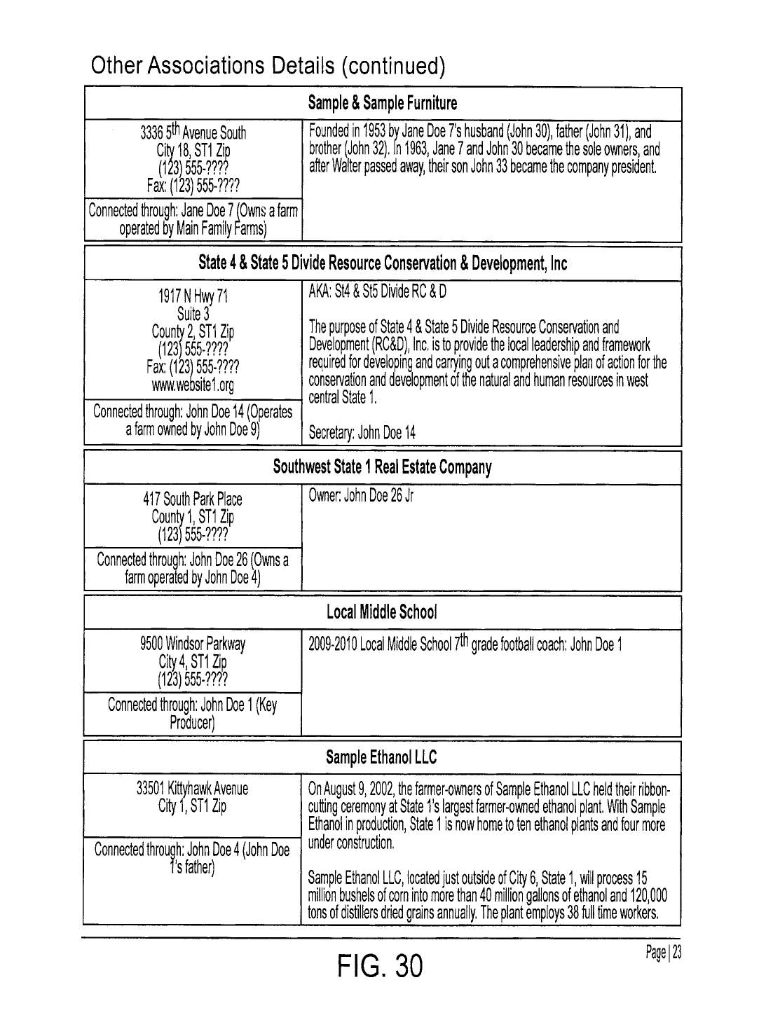

FIG. 30 is page 23 of the first exemplary written analysis based on generated models, and includes

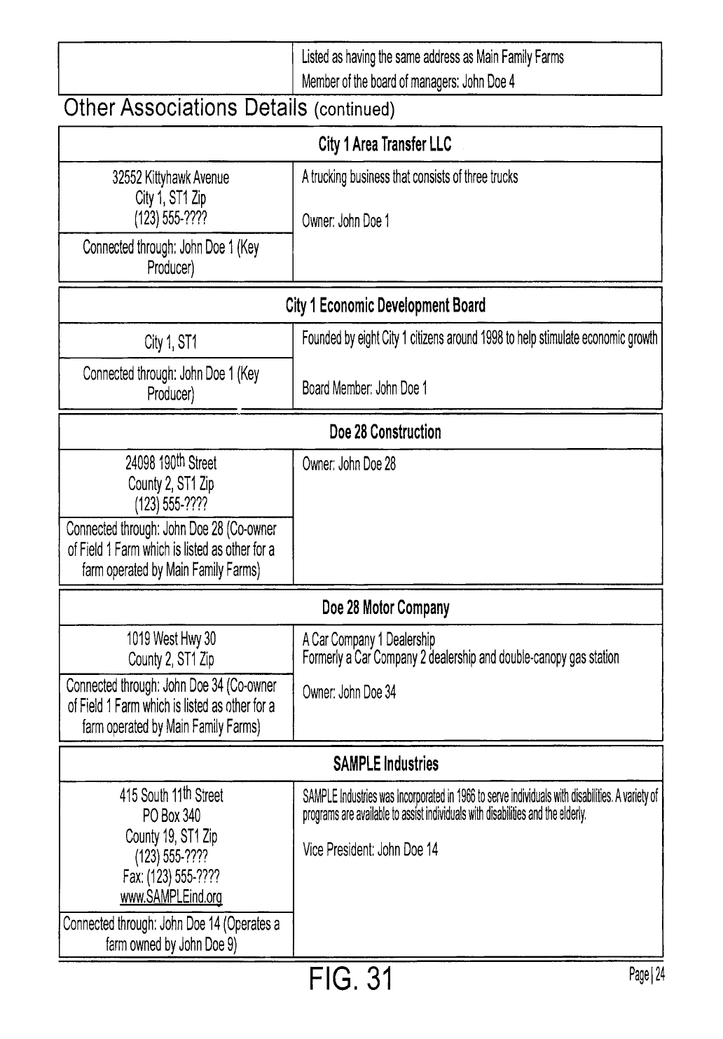

FIG. 31 is page 24 of the first exemplary written analysis based on generated models, and includes

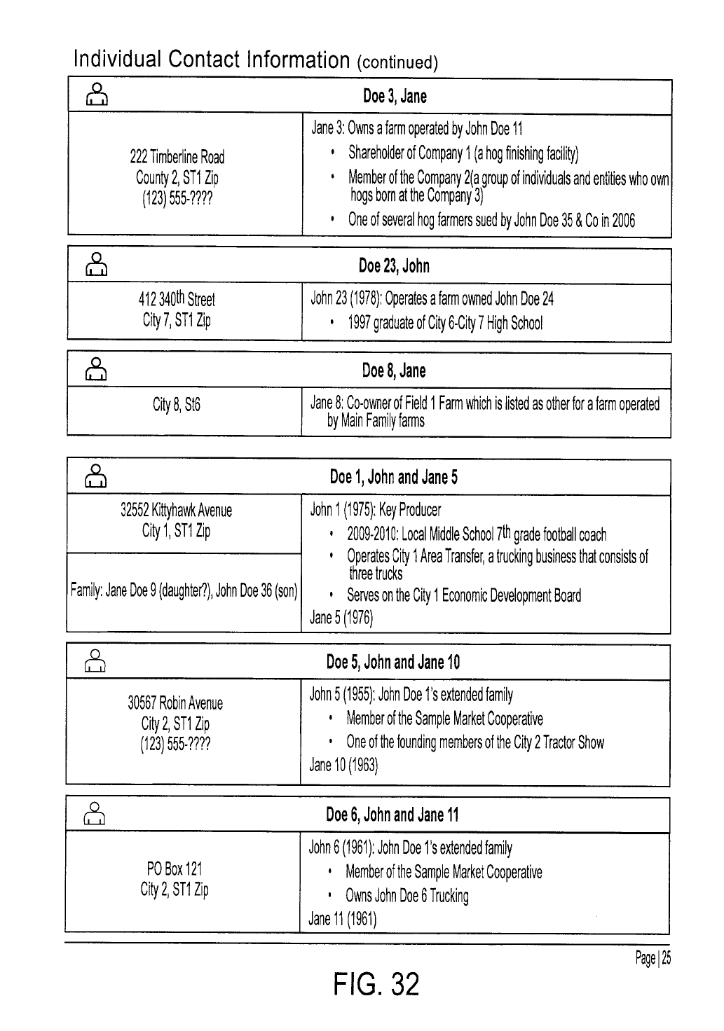

FIG. 32 is page 25 of the first exemplary written analysis based on generated models, and includes

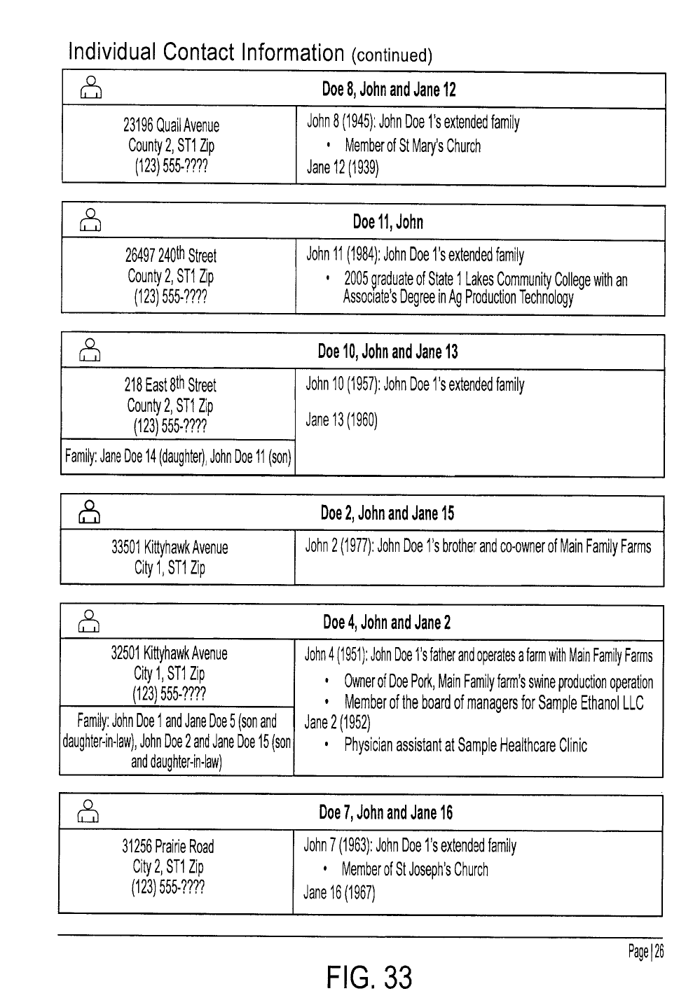

FIG. 33 is page 26 of the first exemplary written analysis based on generated models, and includes

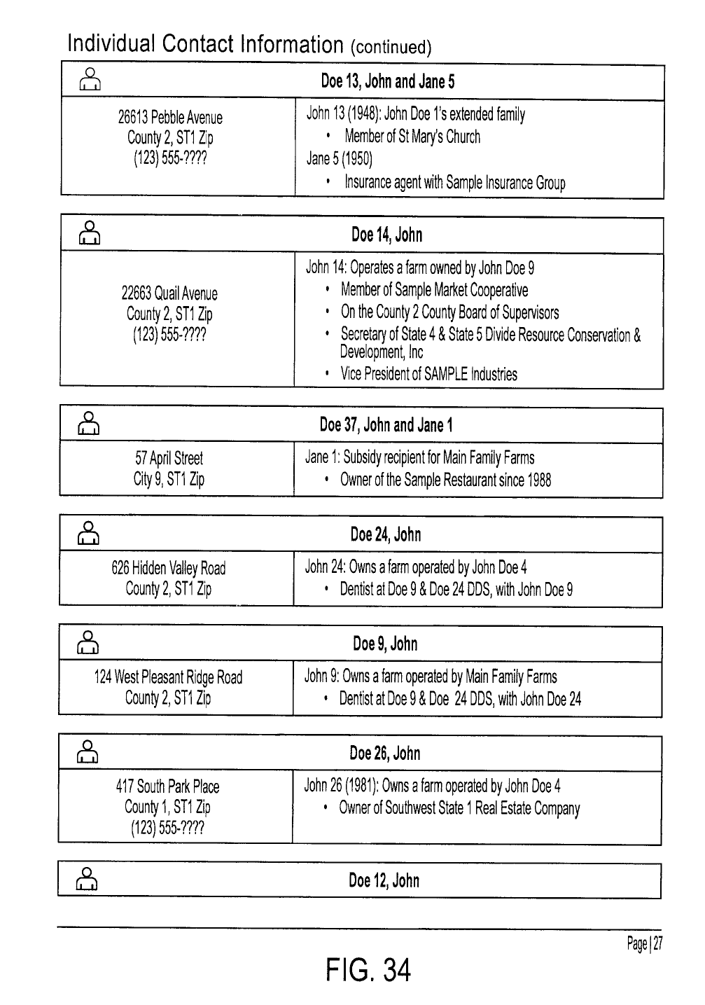

FIG. 34 is page 27 of the first exemplary written analysis based on generated models, and includes

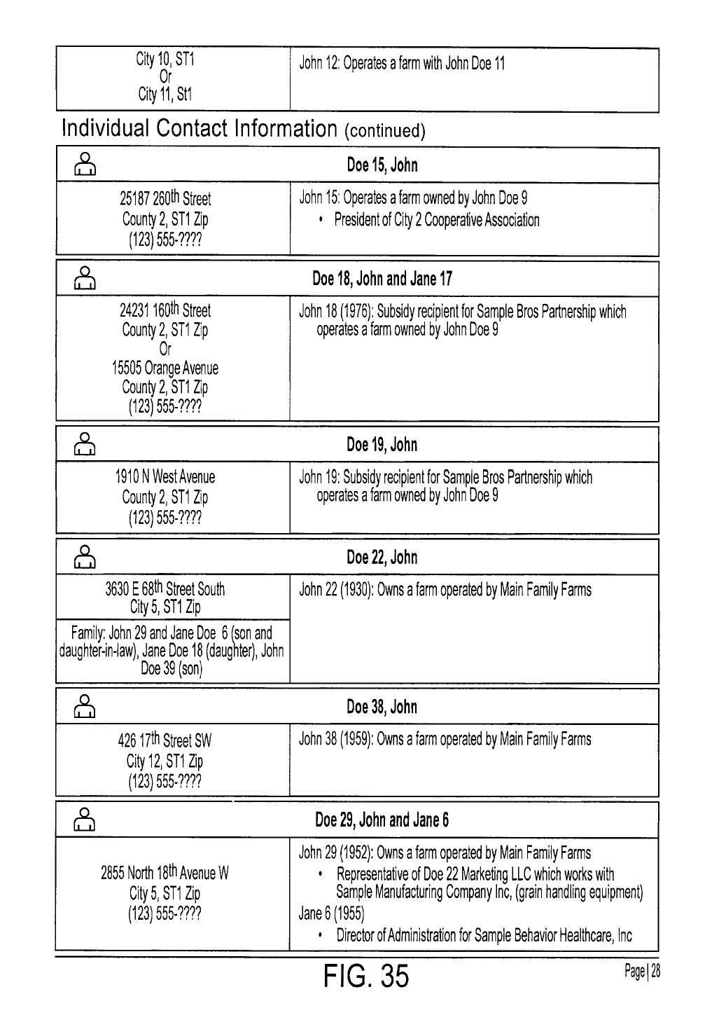

FIG. 35 is page 28 of the first exemplary written analysis based on generated models, and includes

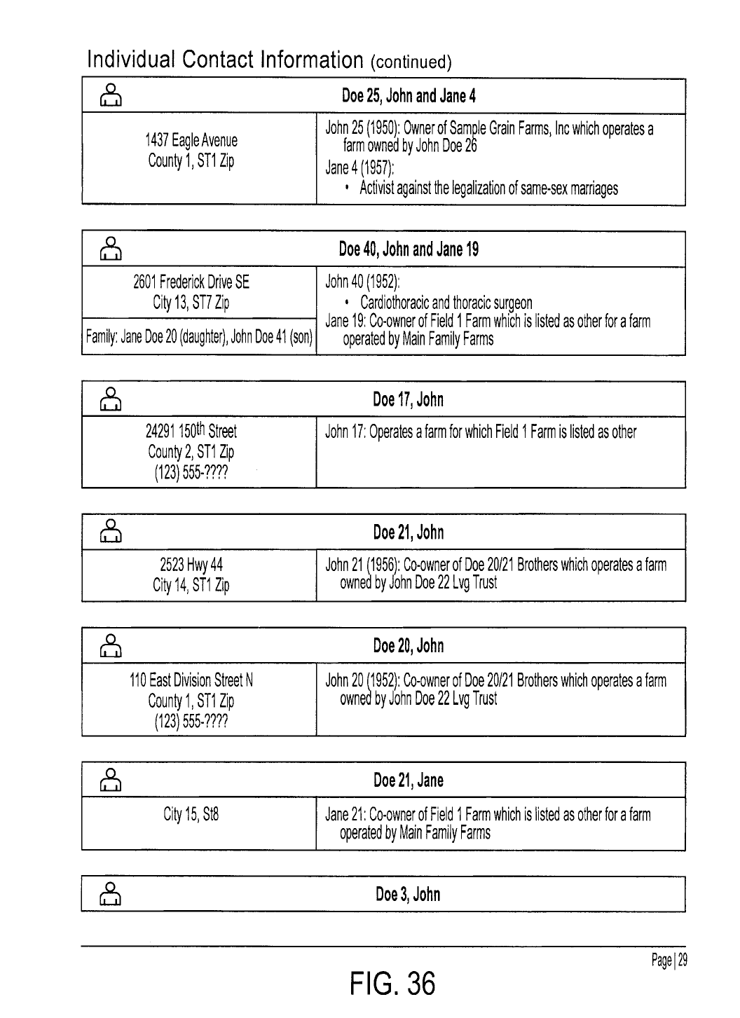

FIG. 36 is page 29 of the first exemplary written analysis based on generated models, and includes

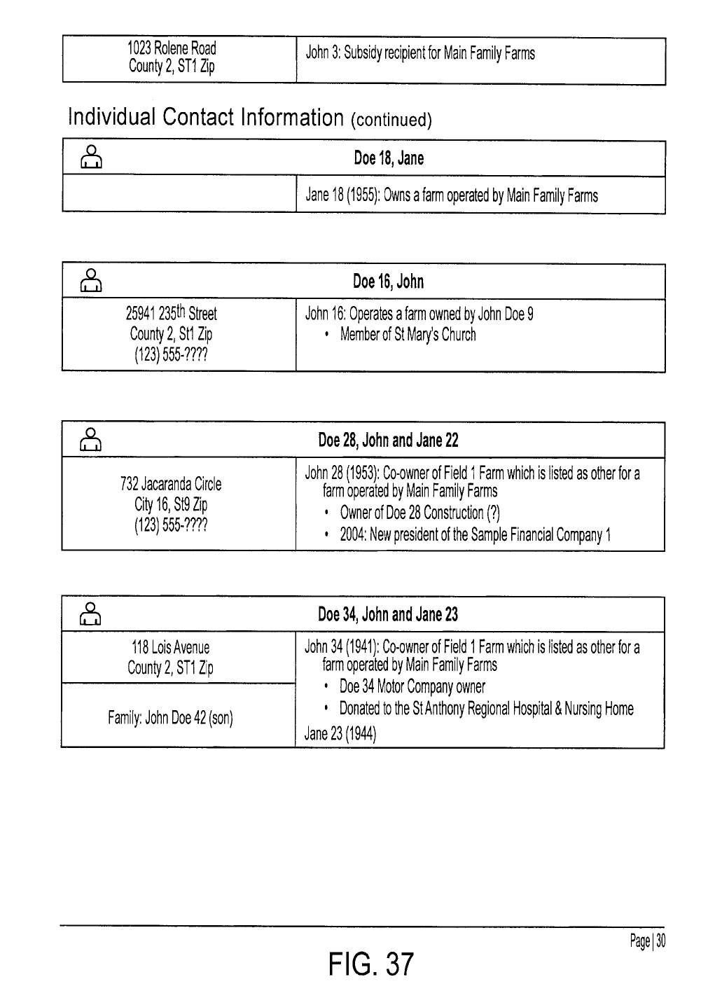

FIG. 37 is page 30 of the first exemplary written analysis based on generated models, and includes

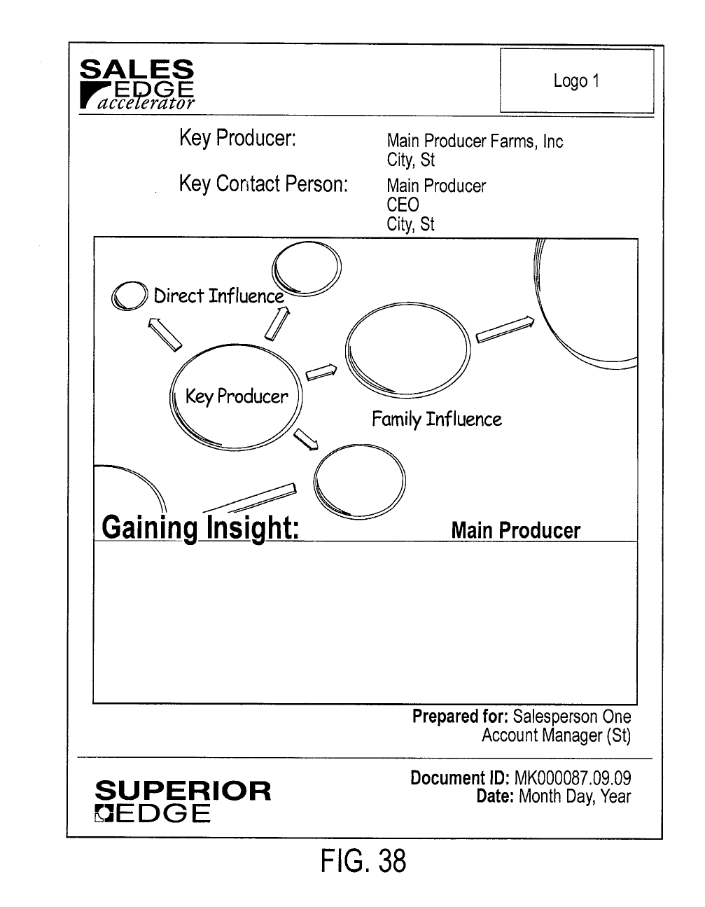

FIGS. 38-61 are pages from a second exemplary written analysis based on generated models. These FIGS. are discussed in more detail below.

FIG. 38 is a cover page of the second exemplary written analysis based on generated models. The cover page includes a title and contact information.

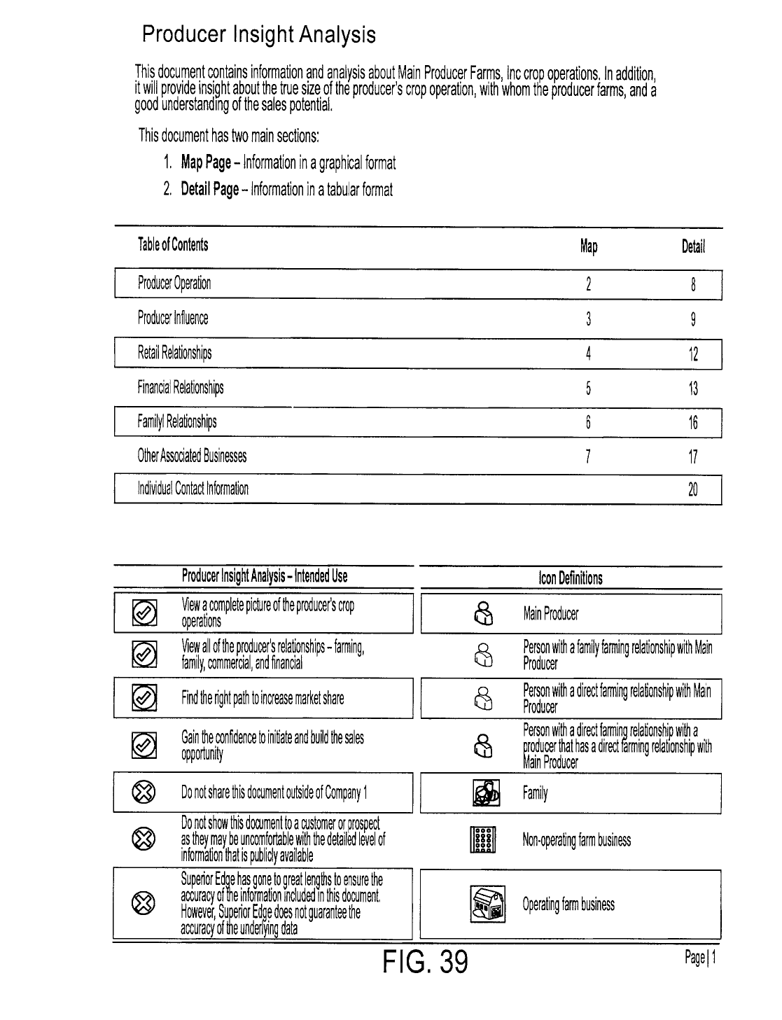

FIG. 39 is page 1 of the second exemplary written analysis based on generated models, and includes a table of contents and icon definitions.

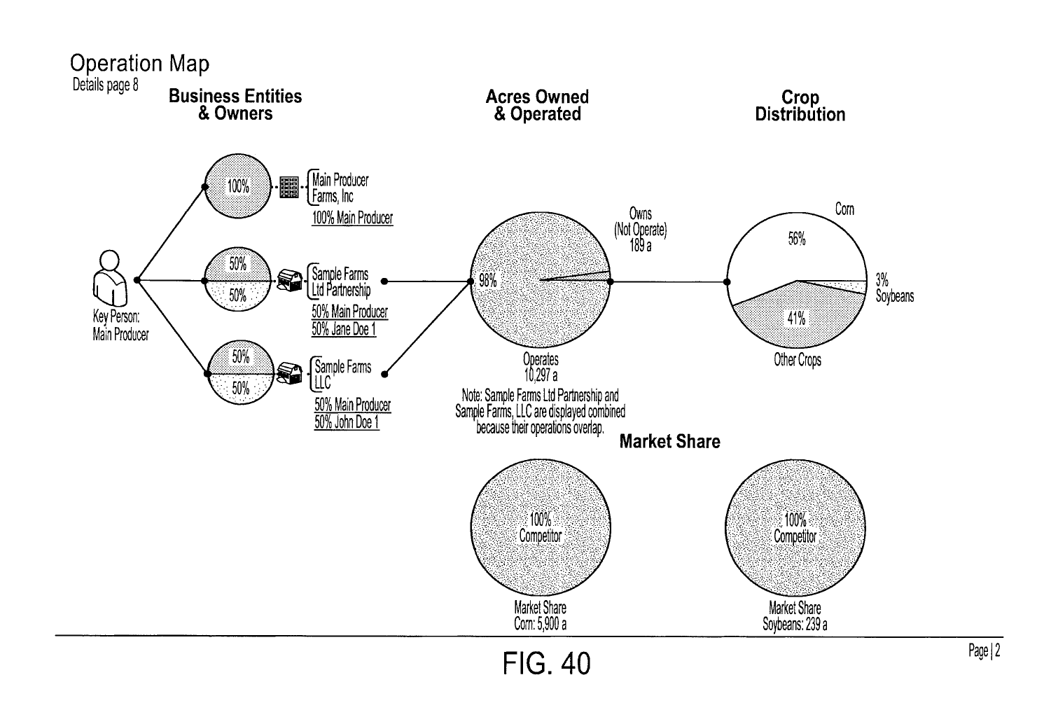

FIG. 40 is page 2 of the second exemplary written analysis based on generated models, and includes an operation map. In this context, the term “map” may be used instead of the more technical term “model,” in order to facilitate understanding by a user.

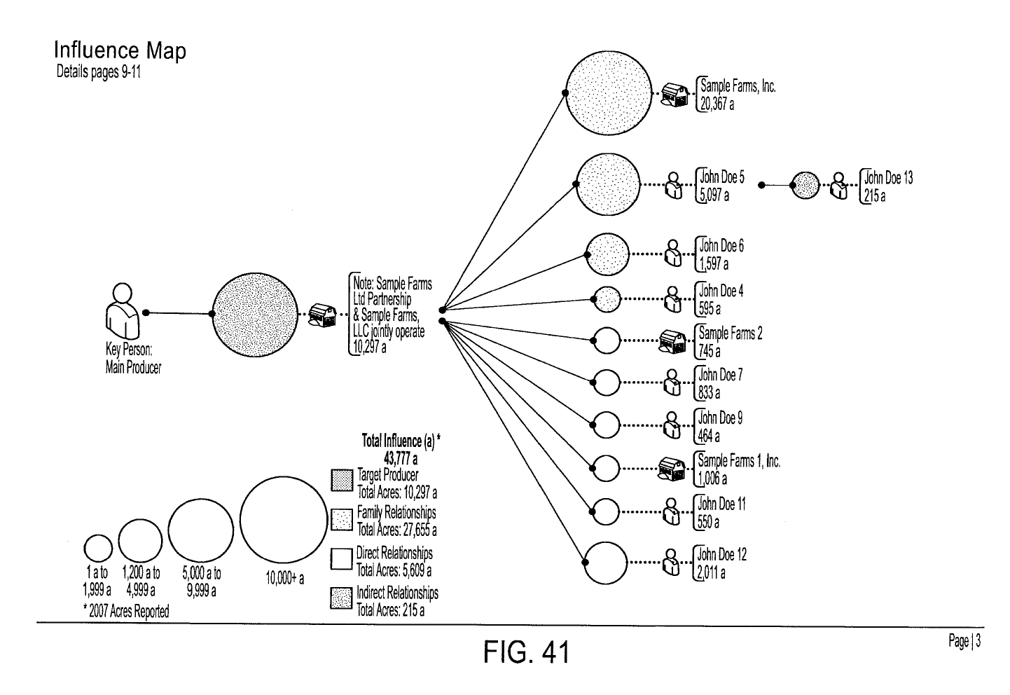

FIG. 41 is page 3 of the second exemplary written analysis based on generated models, and includes an influence map.

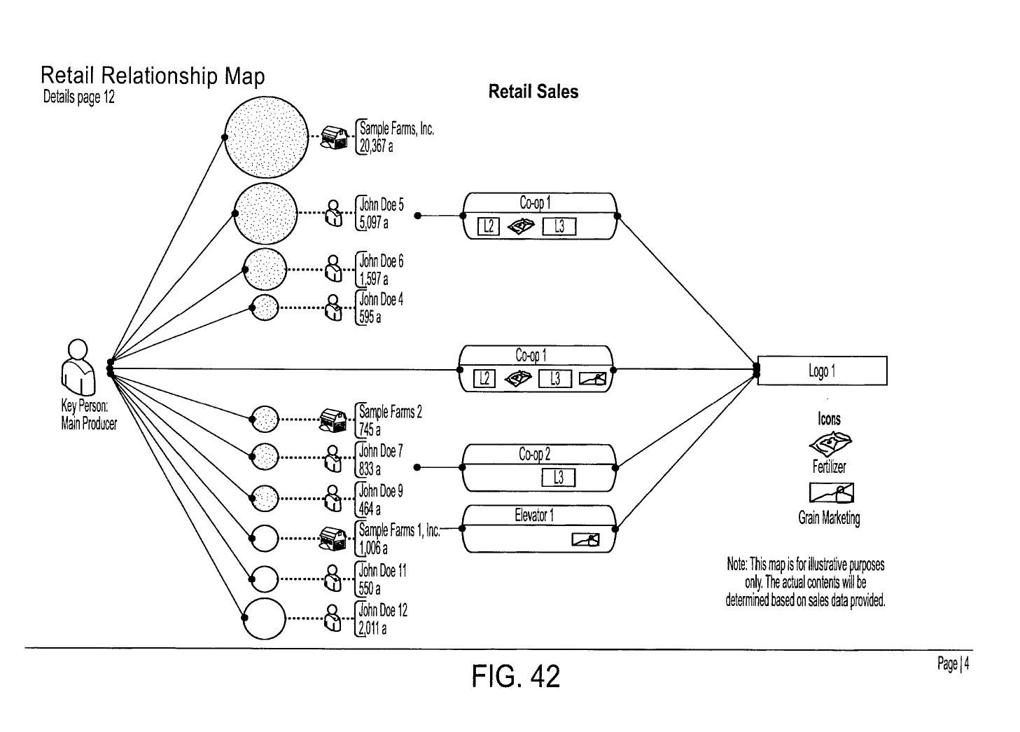

FIG. 42 is page 4 of the second exemplary written analysis based on generated models, and includes a retail relationship map, and includes information about a farming operation and a family tree of the family involved in the farming operation.

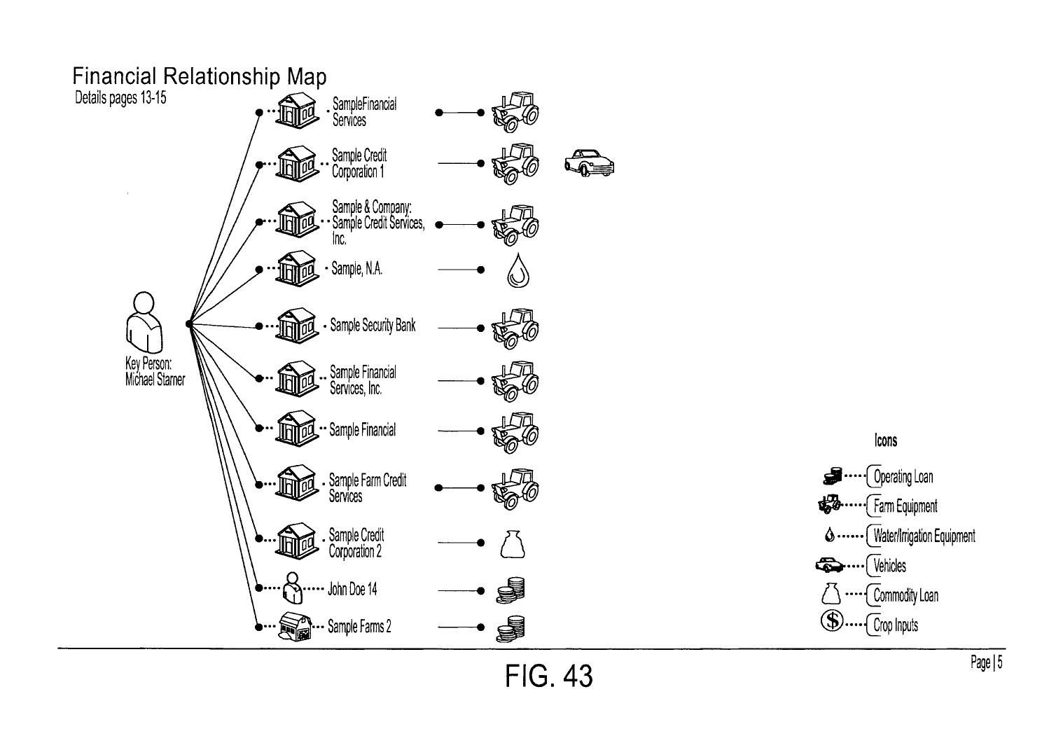

FIG. 43 is page 5 of the second exemplary written analysis based on generated models, and includes a financial relationship map.

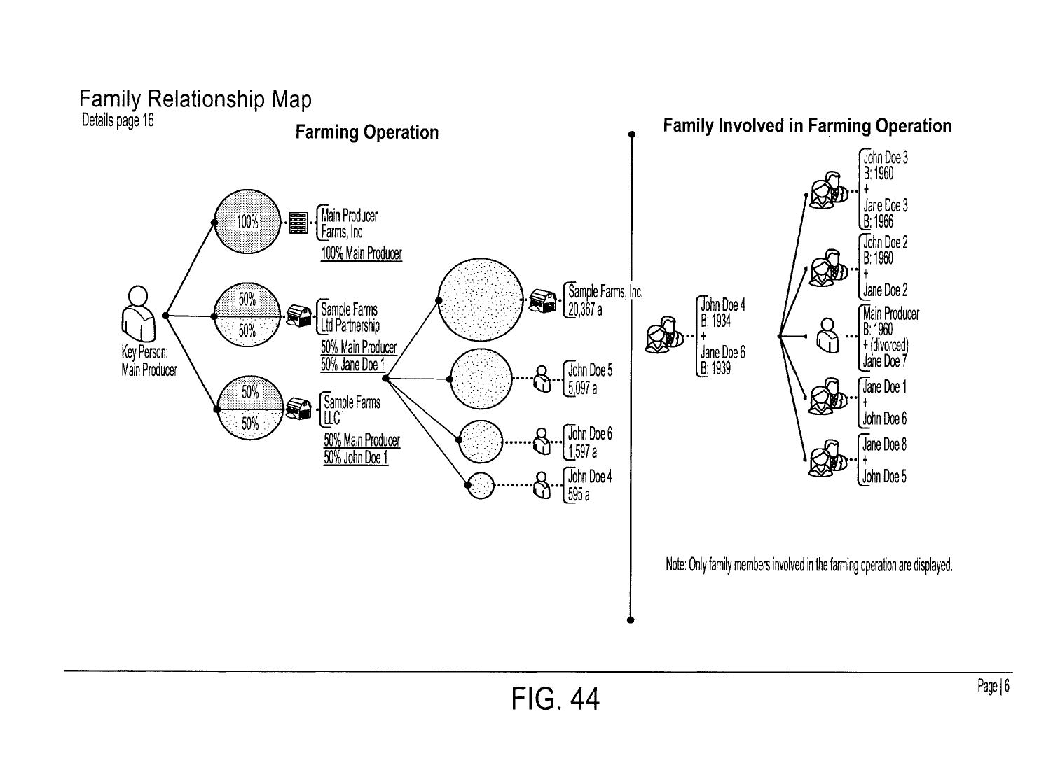

FIG. 44 is page 6 of the second exemplary written analysis based on generated models, and includes a farming operation map and a family tree of family members involved in the farming operation.

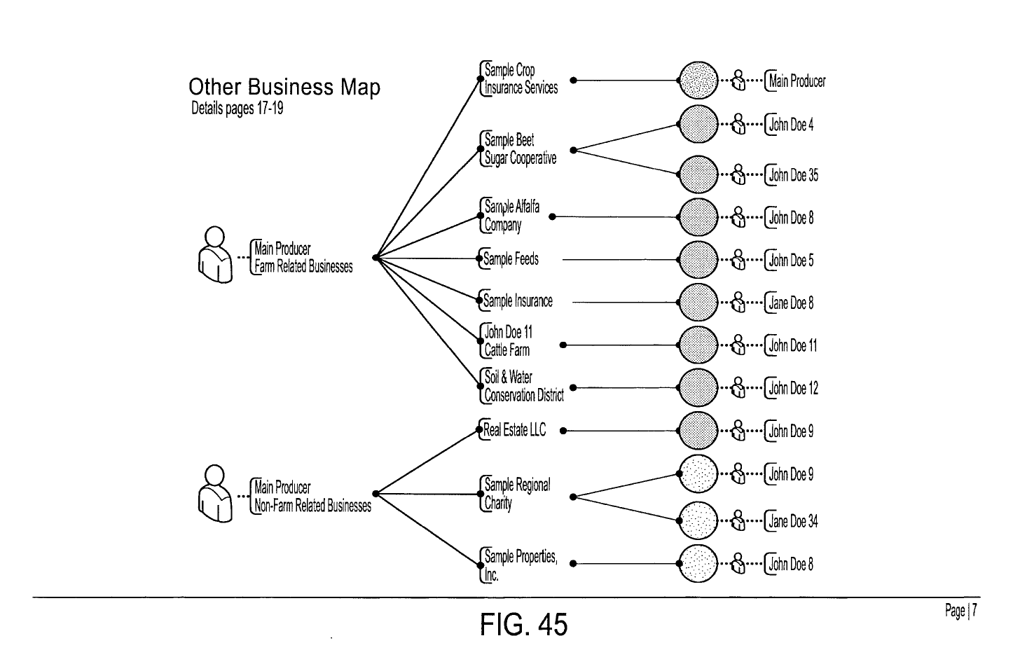

FIG. 45 is page 7 of the second exemplary written analysis based on generated models, and includes separate business maps regarding farming and non-farming businesses with which a key person or decision maker is involved.

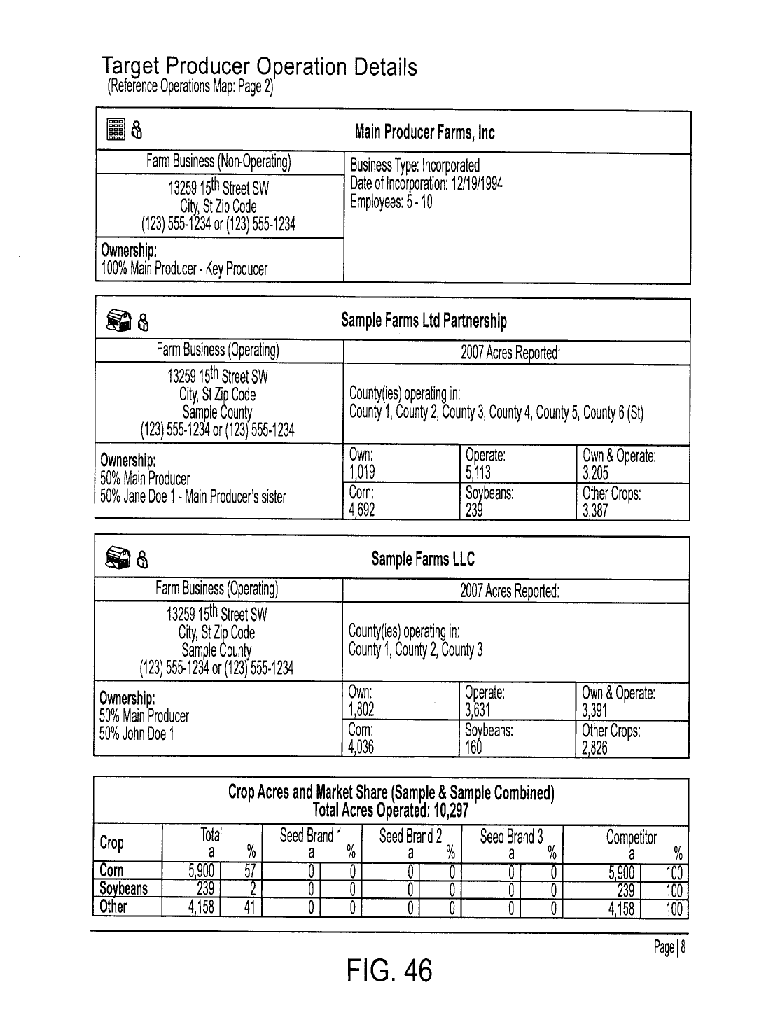

FIG. 46 is page 8 of the second exemplary written analysis based on generated models, and includes target producer operation details. These details may be stored in a relational database, and then used to generate models.

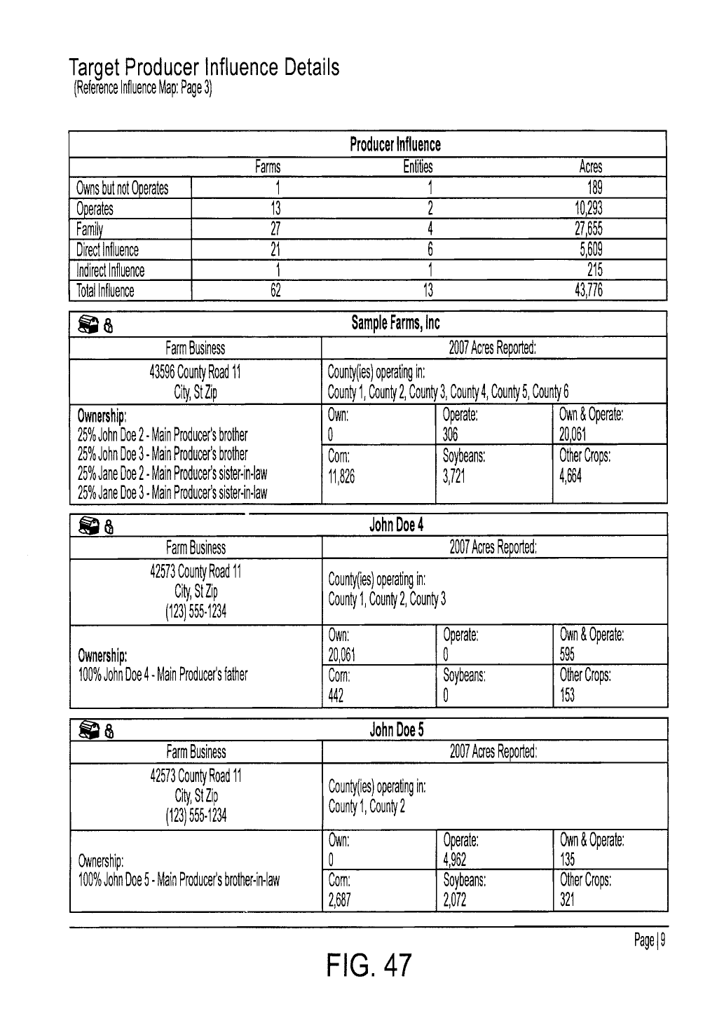

FIG. 47 is page 9 of the second exemplary written analysis based on generated models, and includes target producer influence details.

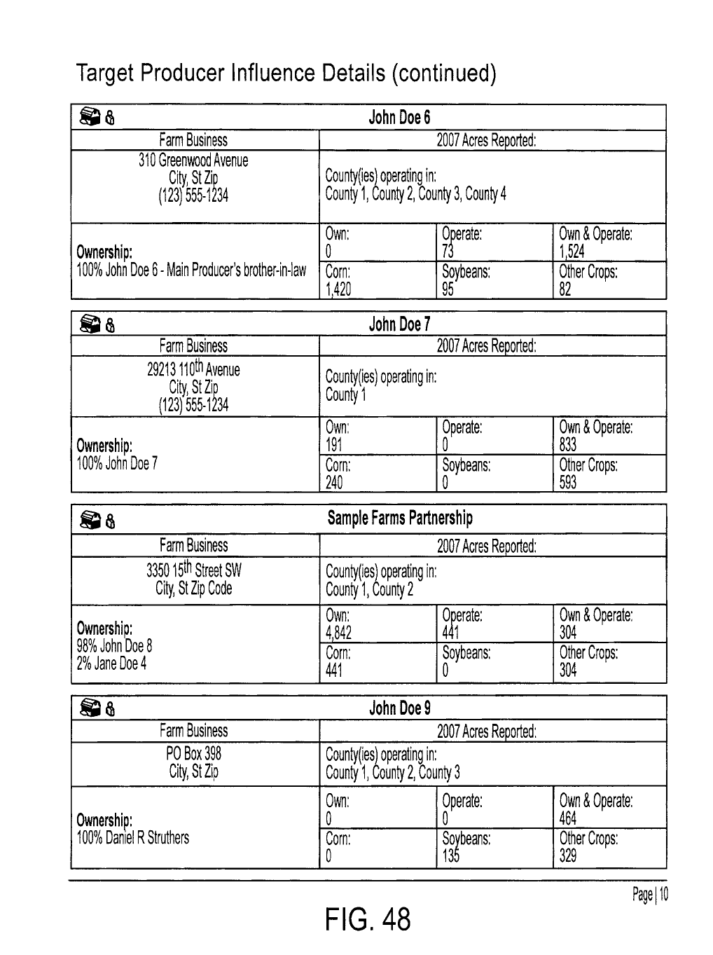

FIG. 48 is page 10 of the second exemplary written analysis based on generated models, and includes additional target producer influence details.

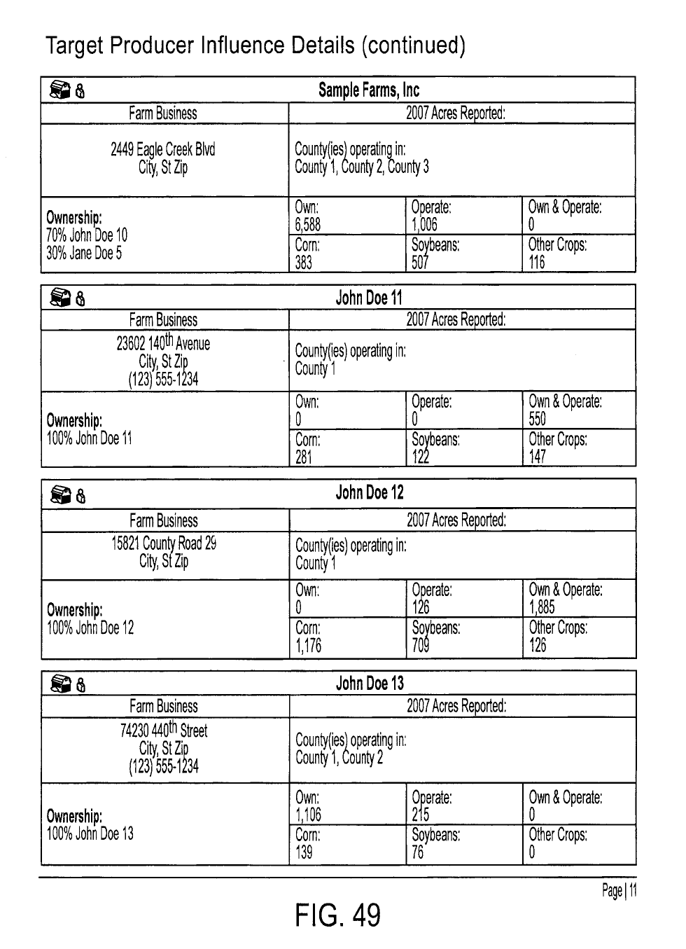

FIG. 49 is page 11 of the second exemplary written analysis based on generated models, and includes additional target producer influence details.

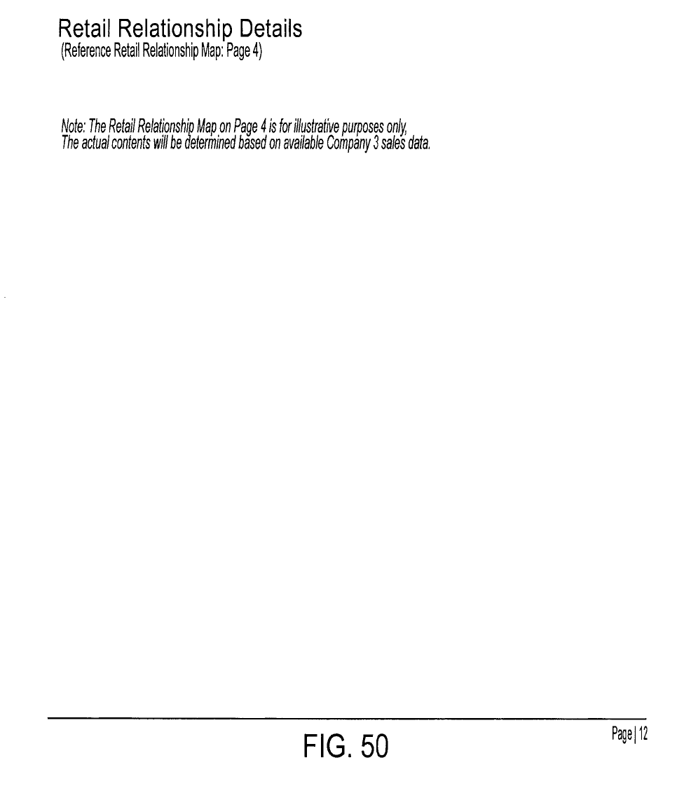

FIG. 50 is page 12 of the second exemplary written analysis based on generated models, and includes retail relationship details.

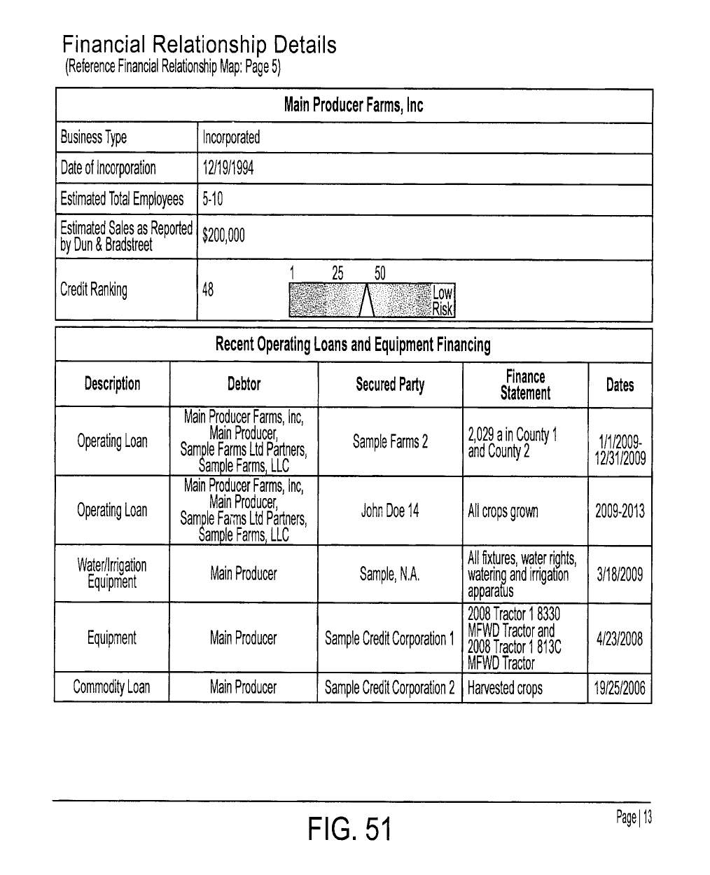

FIG. 51 is page 13 of the second exemplary written analysis based on generated models, and includes financial relationship details.

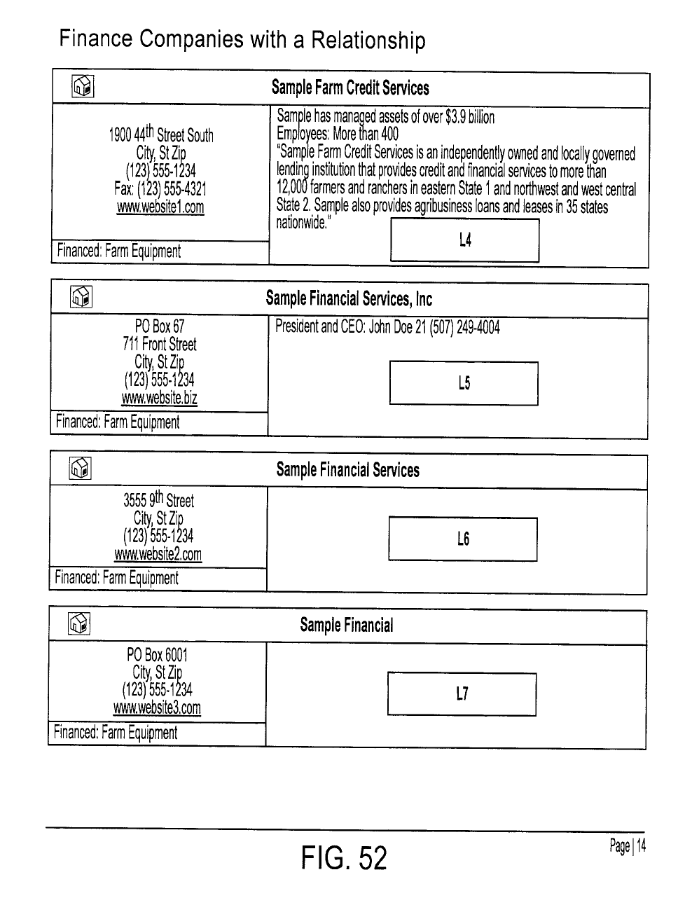

FIG. 52 is page 14 of the second exemplary written analysis based on generated models, and includes details of the finance companies having a relationship.

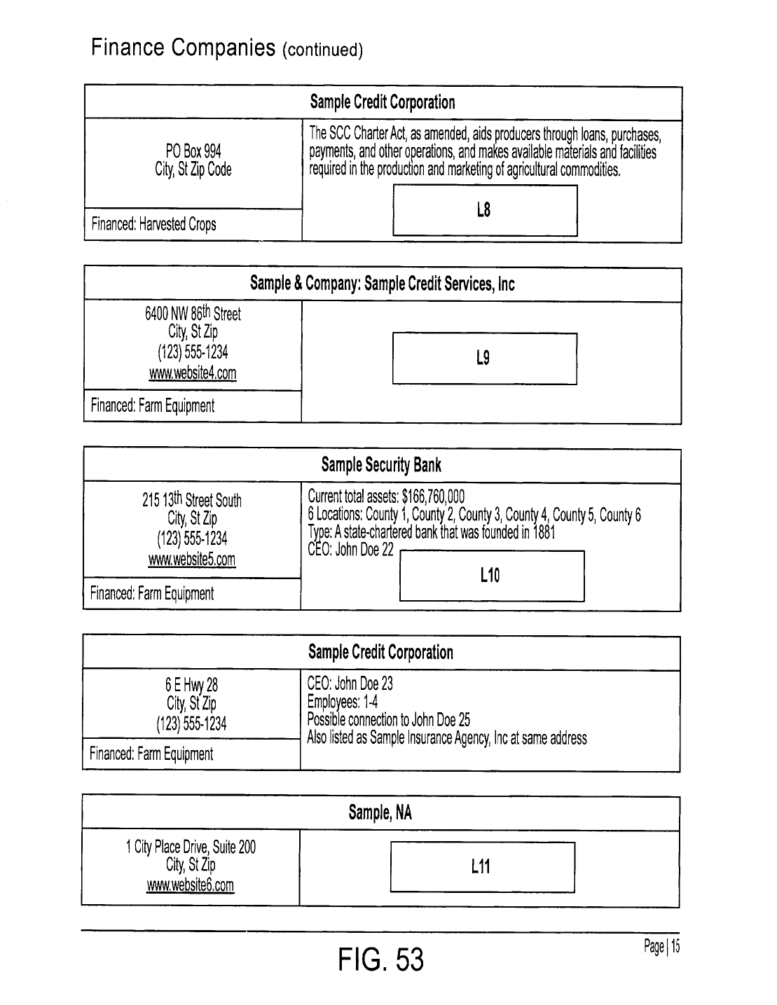

FIG. 53 is page 15 of the second exemplary written analysis based on generated models, and includes additional details of the finance companies having a relationship.

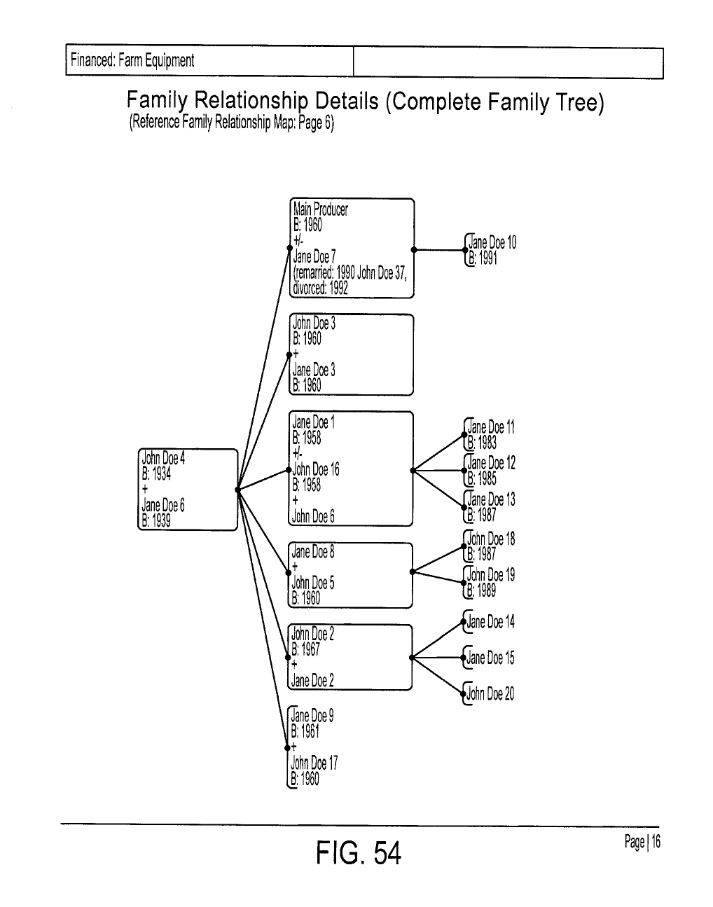

FIG. 54 is page 16 of the second exemplary written analysis based on generated models, and includes family relationship details such as a complete family tree.

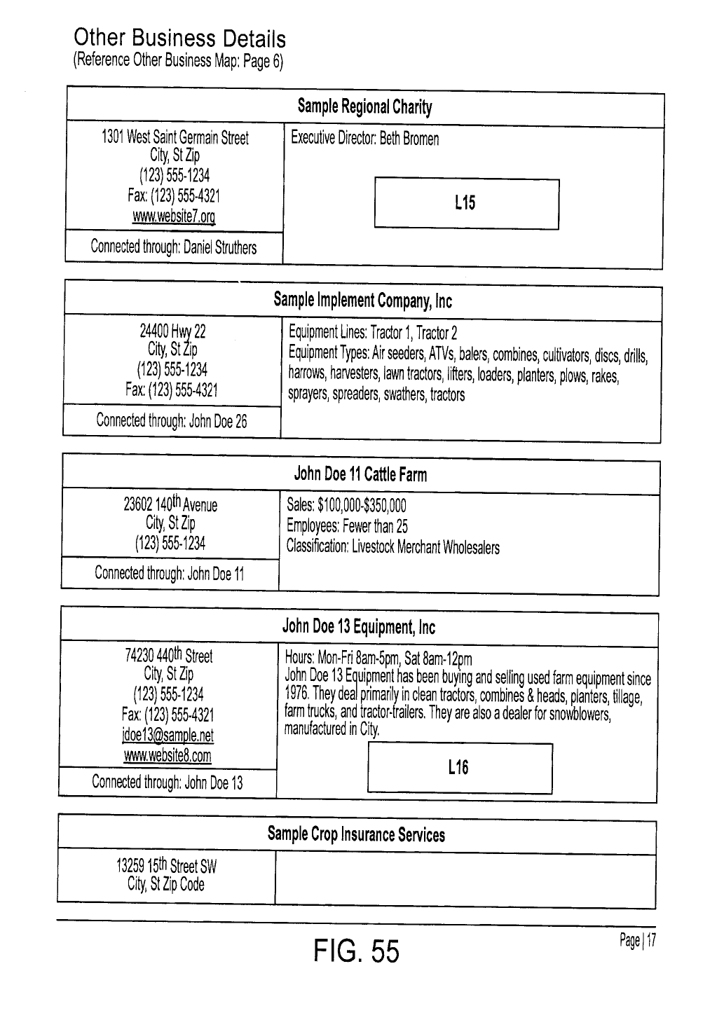

FIG. 55 is page 17 of the second exemplary written analysis based on generated models, and includes other business details.

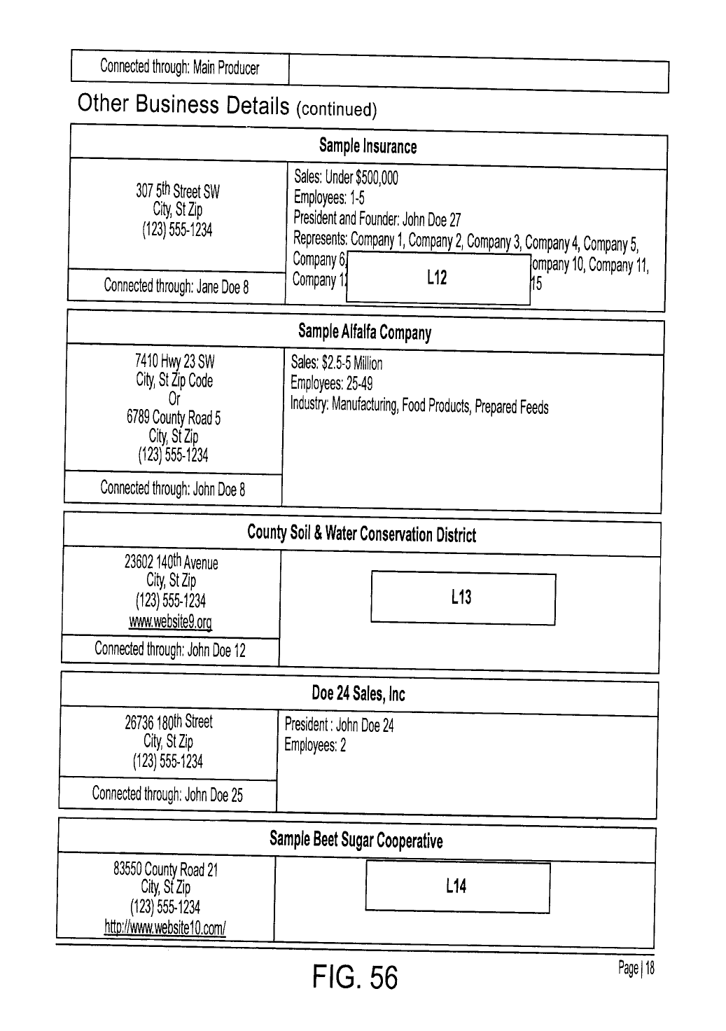

FIG. 56 is page 18 of the second exemplary written analysis based on generated models, and includes additional other business details.

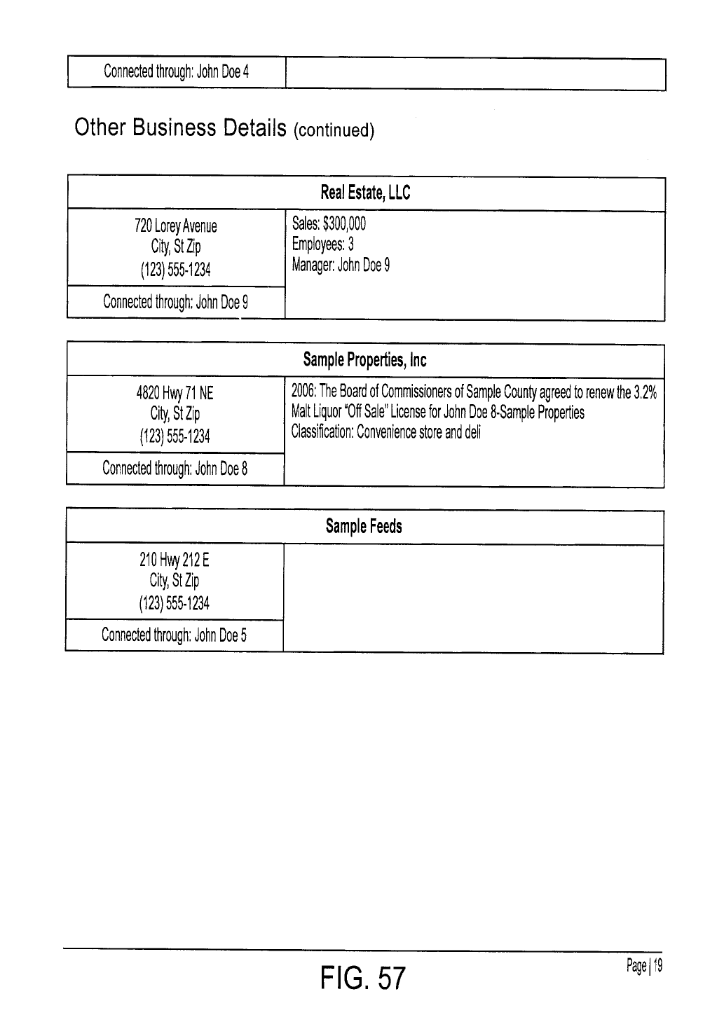

FIG. 57 is page 19 of the second exemplary written analysis based on generated models, and includes additional other business details.

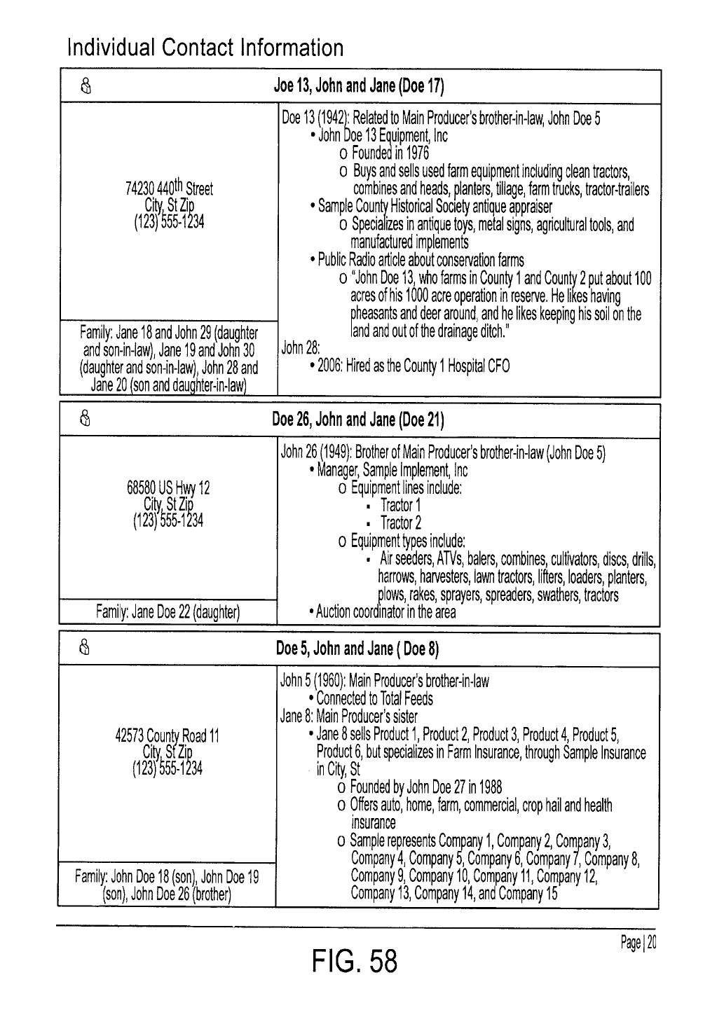

FIG. 58 is page 20 of the second exemplary written analysis based on generated models.

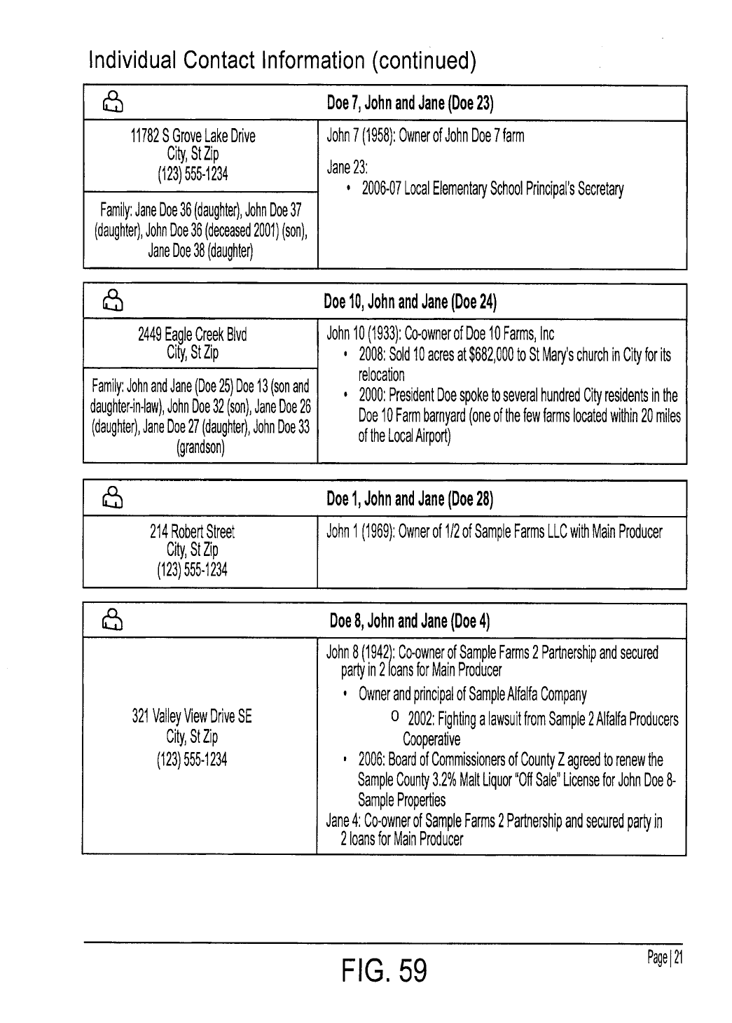

FIG. 59 is page 21 of the second exemplary written analysis based on generated models, and includes individual contact information.

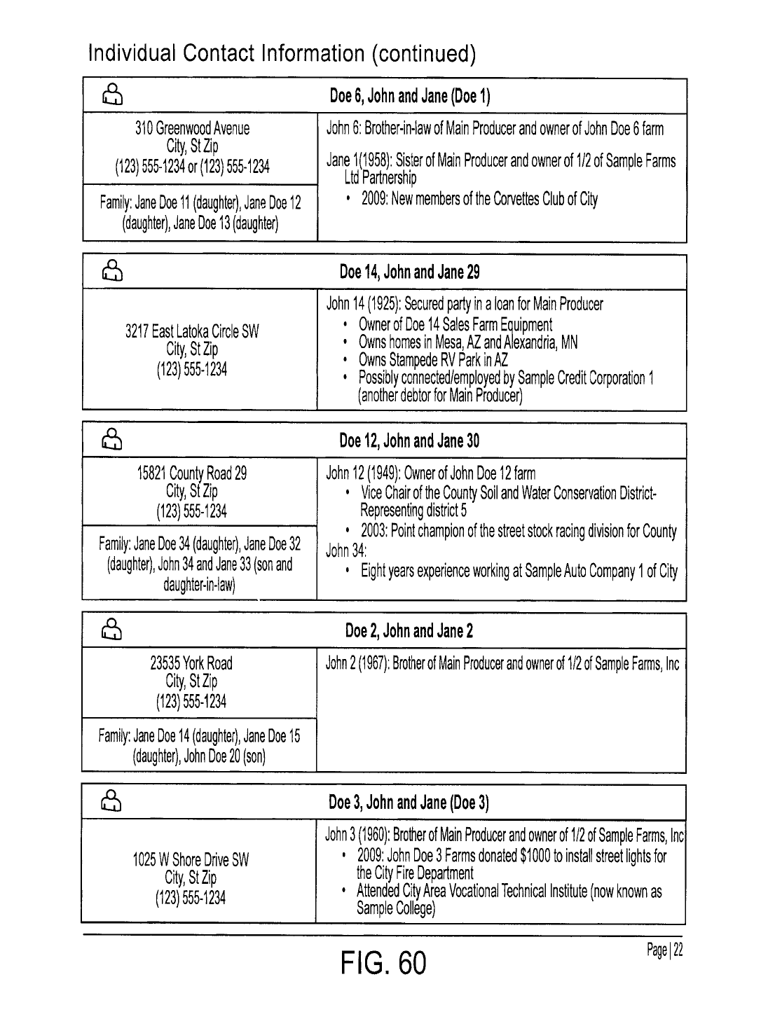

FIG. 60 is page 22 of the second exemplary written analysis based on generated models, and includes additional individual contact information.

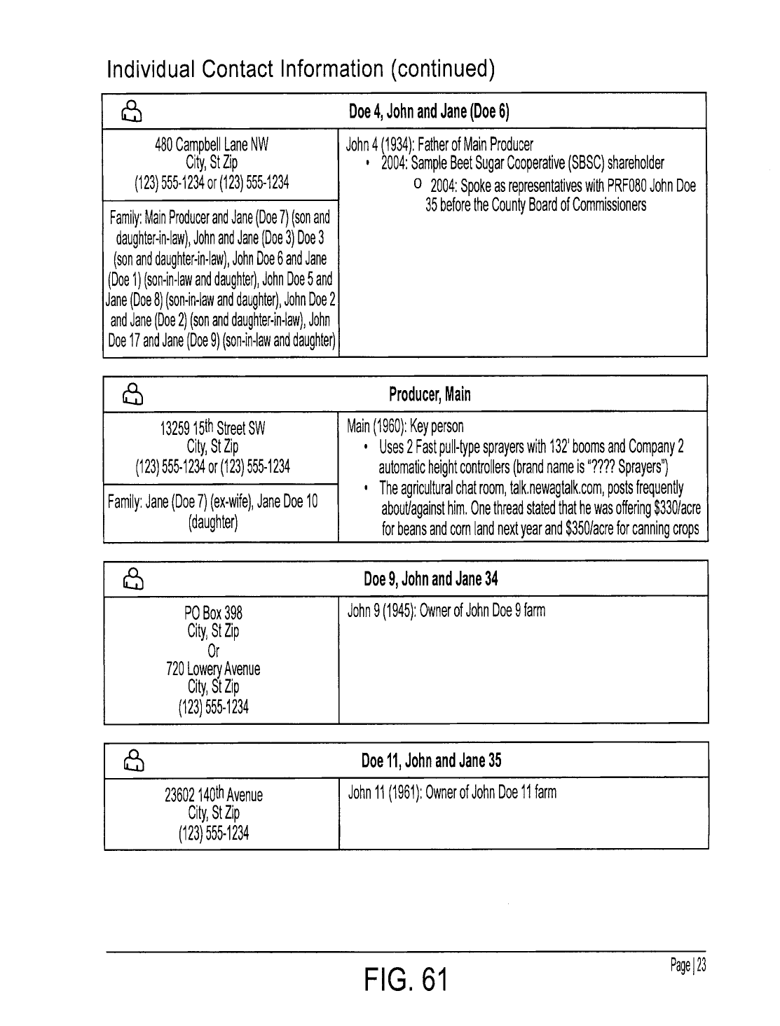

FIG. 61 is page 23 of the second exemplary written analysis based on generated models, and includes additional individual contact information.

While the foregoing has described what are considered to be the best mode and/or other examples, it is understood that various modifications can be made therein and that the subject matter disclosed herein can be implemented in various forms and examples, and that the teachings can be applied in numerous applications, only some of which have been described herein. It is intended by the following claims to claim any and all applications, modifications and variations that fall within the true scope of the present teachings.

What is claimed is:

1. A method of generating an operation model including at least four levels, the method comprising:
generating a decision maker level including a decision maker;
generating a business entity level including a business entity, wherein the business entity is linked to the decision maker;
generating an entity owner level including an owner of a portion of the business entity,
generating an operation level including a type of operation, wherein the type of operation is linked to one of the owner or the business entity;
generating and storing the model including the above levels; and
performing at least one of the above generating steps with a computer.

2. The method of generating an operation model of claim 1, wherein the operation level indicates acres operated by the business entity, and further comprising:
generating a crop distribution level including a crop distribution, wherein the crop distribution is linked to the type of operation.

3. The method of generating an operation model of claim 2, wherein the crop distribution level utilizes a pie chart to indicate acreage allocated to each type of crop.

4. The method of generating an operation model of claim 1, wherein the decision maker level is generated before the business entity level is generated.

5. The method of generating an operation model of claim 1, wherein the business entity level is generated before the decision maker level is generated.

6. The method of generating an operation model of claim 1, wherein the entity ownership level graphically indicates a family relationship between the owner and the decision maker.

7. The method of generating an operation model of claim 6, wherein the graphically indicated family relationship is intestate succession.

8. The method of generating an operation model of claim 1, wherein the decision maker is linked to the business entity by being an officer of the business entity.

9. The method of generating an operation model of claim 1, wherein the decision maker is linked to the business entity by being a member of the board of directors of the business entity.

10. The method of generating an operation model of claim 1, further comprising:
generating an influence relationship level including an entity with a family relationship or a direct nonfamily relationship.

11. The method of generating an operation model of claim 10, wherein the entity in the influence relationship level graphically indicates a family relationship with the decision maker.

12. The method of generating an operation model of claim 10, wherein an entity in the influence relationship level graphically indicates a direct non-family relationship with the decision maker.

13. The method of generating an operation model of claim 10, further comprising:
generating an indirect influence relationship level.

14. A method of generating a retail relationship model, the method comprising:
generating a business entity level including a business entity;
generating an influence relationship level including an influence entity, wherein the influence entity has an influence relationship with the business entity;
generating a sales relationship level having a retailer, wherein the retailer is linked to the influence entity;
generating a wholesaler level having a wholesaler, wherein the wholesaler is linked to the retailer;
generating and storing the model including the above levels; and
performing at least one of the above generating steps with a computer.

15. The method of claim 14, wherein the influence relationship is a family relationship.

16. The method of claim 14, wherein the influence relationship is ownership of a portion of the business entity.

17. The method of claim 14, wherein the influence relationship is a direct non-family and non-ownership relationship with the business entity.

18. The method of claim 14, wherein the sales relationship level graphically indicates a type of product that the retailer sells.

19. A method of generating a financial relationship model including at least four levels, the method comprising:
generating a decision maker level including a decision maker;
generating a business entity level including a business entity, wherein the business entity is linked to the decision maker;
generating an entity owner level including an owner of a portion of the business entity;
generating a financial organization level including a financial organization;
generating and storing the model including the above levels; and
performing at least one of the above generating steps with a computer.

20. The method of claim 19, wherein the financial organization has a contractual relationship with the business entity.

21. The method of claim 20, wherein the contractual relationship includes at least one of the following: commodity loan, farm equipment loan, operation loan, and landlord lien.

22. A method of generating a family relationship model including at least three levels, the method comprising:
generating a business entity level including a business entity;
generating an entity owner level including an owner of a portion of the business entity;
generating a family relationship level including a family relationship;
generating and storing the model including the above levels; and
performing at least one of the above generating steps with a computer.

23. The method of claim 22, wherein the family relationship is a family relationship with the owner.

24. The method of claim 23, wherein the family relationship is intestate succession.

25. The method of claim 24, wherein a priority of the intestate succession is indicated with a graphical indication.

26. The method of claim 25, wherein the graphical indication utilizes a thickness of a linking line to indicate a priority of the intestate succession family relationship.

27. The method of claim 22, wherein the family relationship level includes an icon with an area indicating a value of an operation metric associated with the business entity.
